(19) United States
(12) Patent Application Publication
(10) Pub. No.: US 2026/0218342 A1
(43) Pub. Date: Jul. 30, 2026

(54) METAL-CARBON COMPOSITES AND USES THEREOF

(71) Applicant: B.G. NEGEV TECHNOLOGIES AND APPLICATIONS LTD., AT BEN-GURION UNIVERSITY, Beer Sheva (IL)

(72) Inventors: Menashe SHALOM, Beer Sheva (IL); Jonathan TZADIKOV, Beer Sheva (IL); Alagar Raja KOTTAICHAMY, Beer Sheva (IL); Michael VOLOKH, Beer Sheva (IL)

(21) Appl. No.: 19/145,907

(22) PCT Filed: Jan. 5, 2024
(86) PCT No.: PCT/IL2024/050019

§ 371 Date: Jul. 4, 2025

Related U.S. Application Data
(60) Provisional application No. 63/478,573, filed on Jan. 5, 2023.
(60) Provisional application No. 63/522,428, filed on Jun. 22, 2023.

(51) Int. Cl. C22C 29/06; H01M 4/36; H01M 12/06

(52) U.S. Cl. CPC C22C 29/067; H01M 4/364; H01M 12/06

(57) ABSTRACT

The present disclosure relates to composite material comprising metal, carbon and optionally heteroatoms and methods of their use in electrochemical reactions.

### TECHNOLOGICAL FIELD

The present disclosure relates to metal-carbon composites and uses thereof.

### BACKGROUND ART

References considered to be relevant as background to the presently disclosed subject matter are listed below:
Tzadikov J. et al. Coordination-Directed Growth of Transition-Metal-Crystalline-Carbon Composites with Controllable Metal Composition, Angew. Chem. Int. Ed. 58, 42, 14964-14968, (2019).

Acknowledgement of the above references herein is not to be inferred as meaning that these are in any way relevant to the patentability of the presently disclosed subject matter.

### BACKGROUND

Tzadikov J. et al. describes transition-metal-carbon that characterizes mono, binary, and ternary transition-metal-crystalline-carbon composites and their electrochemical properties as oxygen evolution reaction electrocatalysts.

### GENERAL DESCRIPTION

In accordance with some aspects, it is provided a composite material represented by a formula M/C, wherein M is at least one metal material and C is at least one carbon material, wherein said composite material is for electrocatalysis in an oxygen reduction reaction (ORR) and/or in a peroxide oxidation reaction (POR).

In accordance with some other aspects, it is provided a composite material represented by a formula M/C, wherein M is at least one metal material and C is at least one carbon material, wherein said composite material is for electrocatalysis in an oxygen reduction reaction (ORR).

In accordance with some further aspects, it is provided a composite material represented by a formula M/C, wherein M is at least one metal material and C is at least one carbon material, wherein said composite material is for electrocatalysis in a peroxide oxidation reaction (POR).

In accordance with yet some aspects, it is provided a composite material represented by a formula M/C, wherein M is at least one metal material and C is at least one carbon material, wherein said composite material is for reversible electrocatalysis in an oxygen reduction reaction (ORR) and in a peroxide oxidation reaction (POR).

In accordance with yet some other aspects, it is provided an electrochemical cell comprising an electrode assembly comprising a working electrode and a counter electrode, wherein said working electrode is or is at least partially coated with a composite material represented by a formula M/C, wherein M is at least one metal material and C is at least one carbon material.

In accordance with yet some further aspects, it is provided an electrochemical cell comprising an electrode assembly comprising a working electrode and a counter electrode, wherein said working electrode is or is at least partially coated with a composite material wherein said composite material is for electrocatalysis in an oxygen reduction reaction (ORR) and/or in a peroxide oxidation reaction (POR).

In accordance with some aspects, it is provided a battery comprising an electrode assembly comprising a working electrode and a counter electrode, wherein said working electrode is or comprises a material that exhibits reversible activity for the reduction of oxygen to H₂O₂ or HO₂⁻ during ORR and for the oxidation of H₂O₂ or HO₂⁻ to oxygen during POR.

### EMBODIMENTS

Some embodiments of this disclosure will now be described in the following numbered paragraph. The following description intends to add on the above general description and not limit it in any manner.
1. A catalytic material comprising at least one metal material and at least one carbon material, wherein said catalytic material is for electrocatalysis of a chemical reaction.
2. A catalytic material comprising at least one metal material and at least one carbon material, wherein said catalytic material is for electrocatalysis an oxygen reduction reaction (ORR) of and/or a peroxide oxidation reaction (POR).
3. A composite material represented by a formula M/C, wherein M is at least one metal material and C is at least one carbon material, wherein said composite material is for electrocatalysis of ORR and/or POR.
4. A composite material represented by a formula M/C, wherein M is at least one metal material and C is at least one carbon material, wherein said composite material is for reversible electrocatalysis of ORR and POR.
5. A composite material comprising at least one metal material, at least one carbon material and at least one heteroatom.
6. A composite material represented by a formula MX/C, wherein M is at least one metal material, C is at least one carbon material and X is at least one heteroatom.
7. A composite material represented by a formula M/CX, wherein M is at least one metal material, C is at least one carbon material and X is at least one heteroatom.
8. A composite material represented by a formula MX/C, wherein M is at least one metal material, C is at least one carbon material and X is at least one heteroatom, for electrocatalysis an oxygen reduction reaction (ORR) of and/or a peroxide oxidation reaction (POR).
9. A composite material represented by a formula M/CX, wherein M is at least one metal material, C is at least one carbon material and X is at least one heteroatom, for electrocatalysis an oxygen reduction reaction (ORR) of and/or a peroxide oxidation reaction (POR).
10. A composite material represented by a formula MX/C, wherein M is at least one metal material, C is at least one carbon material and X is at least one heteroatom, for use in nitrate reduction reaction (NO₃RR).
11. A composite material represented by a formula M/CX, wherein M is at least one metal material, C is at least one carbon material and X is at least one heteroatom, for use in nitrate reduction reaction (NO₃RR).
12. The composite material of any one of the preceding Embodiments.
13. Use of a composite material represented by a formula M/C, wherein M is at least one metal material and C is at least one carbon material in electrocatalysis of ORR and/or POR.
14. Use of a composite material represented by a formula M/C, wherein M is at least one metal material and C is at least one carbon material in electrocatalysis of ORR and/or POR.
15. Use of a composite material comprising at least one metal material, at least one carbon material, and at least one heteroatom in electrocatalysis of chemical reactions.
16. Use of a composite material represented by a formula MX/C, wherein M is at least one metal material, C is at least one carbon material, and X is at least one heteroatom in electrocatalysis of chemical reactions.
17. Use of a composite material represented by a formula M/CX, wherein M is at least one metal material, C is at least one carbon material, and X is at least one heteroatom in electrocatalysis of chemical reactions.
18. Use of a composite material represented by a formula MX/C, wherein M is at least one metal material, C is at least one carbon material, and X is at least one heteroatom in electrocatalysis of ORR and/or POR.
19. Use of a composite material represented by a formula M/CX, wherein M is at least one metal material, C is at least one carbon material, and X is at least one heteroatom in electrocatalysis of ORR and/or POR.
20. Use of a composite material represented by a formula MX/C, wherein M is at least one metal material, C is at least one carbon material, and X is at least one heteroatom in electrocatalysis of NO₃RR.
21. Use of a composite material represented by a formula M/CX, wherein M is at least one metal material, C is at least one carbon material, and X is at least one heteroatom in electrocatalysis of NO₃RR.
22. The use of any one of the preceding Embodiments.
23. A method for electrocatalysis of ORR or POR, the method comprising contacting a composite material represented by a formula M/C, wherein M is at least one metal material and C is at least one carbon material with an oxygen source and/or a solution comprising hydrogen peroxide (H₂O₂) or a peroxide anion (HO₂⁻) allowing said ORR or POR.
24. A method for electrocatalysis of ORR and POR, the method comprising contacting a composite material represented by a formula M/C, wherein M is at least one metal material and C is at least one carbon material with an oxygen source and/or a solution comprising hydrogen peroxide (H₂O₂) or a peroxide anion (HO₂⁻) allowing said ORR and POR.
25. A method for electrocatalysis of NO₃RR, the method comprising contacting a composite material represented by a MX/C, wherein M is at least one metal material, C is at least one carbon material, and X is at least one heteroatom with an oxygen source and/or a solution comprising nitrate allowing said NO₃RR.
26. A method for electrocatalysis of NO₃RR, the method comprising contacting a composite material represented by a MX/C, wherein M is at least one metal material, C is at least one carbon material, and X is at least one heteroatom with an oxygen source and/or a solution comprising nitrate allowing said NO₃RR.
27. A method for electrocatalysis of NO₃RR, the method comprising contacting a composite material represented by a M/CX, wherein M is at least one metal material, C is at least one carbon material, and X is at least one heteroatom with an oxygen source and/or a solution comprising nitrate allowing said NO₃RR.
28. The method of any one of the preceding Embodiments.
29. An electrochemical cell comprising an electrode assembly comprising at least a working electrode and a counter electrode, wherein said working electrode is or is at least partially coated with a composite material represented by a formula M/C, wherein M is at least one metal material and C is at least one carbon material.
30. An electrochemical cell comprising two or more electrodes, at least one electrode is configured to catalyze a reduction reaction, wherein the electrode is or comprising a composite material is represented by a formula M/C, wherein M is at least one metal material and C is at least one carbon material.
31. An electrochemical cell comprising two or more electrodes, at least one electrode is configured to support reduction reactions, wherein the electrode is or comprising a composite material is represented by a formula M/C, wherein M is at least one metal material and C is at least one carbon material and wherein the reduction reaction is ORR.
32. An electrochemical cell comprising two or more electrodes, at least one electrode is configured to support oxidation reactions, wherein the electrode is or comprising a composite material is represented by a formula M/C, wherein M is at least one metal material and C is at least one carbon material.
33. An electrochemical cell comprising two or more electrodes, at least one electrode is configured to support oxidation reactions, wherein the electrode is or comprising a composite material is represented by a formula M/C, wherein M is at least one metal material and C is at least one carbon material and wherein the oxidation reaction is POR.
34. An electrochemical cell comprising two or more electrodes, at least one electrode is configured to support reversible oxidation-reduction reactions wherein the electrode is or comprising a composite material wherein the electrode is or comprising a composite material is represented by a formula M/C, wherein M is at least one metal material and C is at least one carbon material.
35. An electrochemical cell two or more electrodes, at least one electrode is configured to support reversible oxidation-reduction reactions wherein the electrode is or comprising a composite material wherein the electrode is or comprising a composite material is represented by a formula M/C, wherein M is at least one metal material and C is at least one carbon material, wherein the reduction reaction is ORR and the oxidation reaction is POR.
36. An ORR flow-cell comprising an electrode assembly comprising at least a working electrode and a counter electrode, wherein said working electrode is or is at least partially coated with a composite material represented by a formula M/C, wherein M is at least one metal material and C is at least one carbon material.
37. An electrolysis cell (electrolyzer) comprising an electrode assembly comprising at least a working electrode and a counter electrode, wherein said working electrode is or is at least partially coated with a composite material represented by a formula M/C, wherein M is at least one metal material and C is at least one carbon material.
38. The cells of any one of the preceding Embodiments.
39. A rechargeable battery comprising an electrode assembly comprising at least a working electrode and a counter electrode, wherein said working electrode is or is at least partially coated with a composite material represented by a formula M/C, wherein M is at least one metal material and C is at least one carbon material.
40. A rechargeable battery comprising an electrode assembly comprising at least a working electrode and a counter electrode, wherein said working electrode is or is at least partially coated with a composite material represented by a formula M/C, wherein M is at least one metal material and C is at least one carbon material and wherein said battery is configured to operate such that during discharge the working electrode serves as a cathode and the counter electrode serves as an anode.
41. A rechargeable battery comprising an electrode assembly comprising at least a working electrode and a counter electrode, wherein said working electrode is or comprises a material that exhibits reversible activity for the reduction of oxygen to H₂O₂ or HO₂⁻ during ORR and for the oxidation of H₂O₂ or HO₂⁻ to oxygen during POR.
42. A rechargeable battery comprising an electrode assembly comprising at least a working electrode and a counter electrode, wherein said working electrode is or comprises a material that exhibits reversible activity for the reduction of oxygen to H₂O₂ or HO₂⁻ during ORR and for the oxidation of H₂O₂ or HO₂⁻ to oxygen during POR and wherein said battery is configured to operate such that during discharge the working electrode serves as a cathode and the counter electrode serves as an anode.
43. The rechargeable battery of any one of the preceding Embodiments.
44. A process for the preparation of a composite material, the process comprising mixing at least one metal source with at least one carbon source under conditions allowing formation of a molten mixture of the metal source and carbon source.
45. The composite material, the use, the method, the cell, the battery, the process of any one of the preceding Embodiments, wherein said ORR comprises reduction of oxygen to hydrogen peroxide (H₂O₂) or a peroxide anion (HO₂⁻).
46. The composite material, the use, the method, the cell, the battery, the process of any one of the preceding Embodiments, wherein said POR comprise oxidation of H₂O₂ or HO₂⁻ to oxygen.
47. The composite material, the use, the method, the cell, the battery, the process of any one of the preceding Embodiments, for use in reversible electrocatalysis of ORR and POR.
48. The composite material, the use, the method, the cell, the battery, the process of any one of the preceding Embodiments, wherein said ORR comprises reduction of oxygen to hydrogen peroxide (H₂O₂) or a peroxide anion (HO₂⁻).
49. The composite material, the use, the method, the cell, the battery, the process of any one of the preceding Embodiments, wherein said ORR comprises a selectivity to H₂O₂ or HO₂⁻ of at least 90%.
50. The composite material, the use, the method, the cell, the battery, the process of any one of the preceding Embodiments, wherein said ORR comprises a selectivity to H₂O₂ or HO₂⁻ of at least 93%.
51. The composite material, the use, the method, the cell, the battery, the process of any one of the preceding Embodiments, wherein said ORR comprises a selectivity to H₂O₂ or HO₂⁻ of at least 95%.
52. The composite material, the use, the method, the cell, the battery, the process of any one of the preceding Embodiments, wherein said ORR involves a two-electrons transfer during oxygen reduction.
53. The composite material, the use, the method, the cell, the battery, the process of any one of the preceding Embodiments, wherein said composite material being stable over at least 100 hours of electrochemical cycling.
54. The composite material, the use, the method, the cell, the battery, the process of any one of the preceding Embodiments, wherein said at least one metal material is at least one of (i) at least one alkali metal, (ii) at least one alkaline earth metal, (iii) at least one transition metal, (iv) at least one post-transition metal or (v) a combination thereof.
55. The composite material, the use, the method, the cell, the battery, the process of any one of the preceding Embodiments, wherein said at least one metal material is at least one of V, Cr, Mn, Fe, Co, Ni, Cu, Zn, Mo, W, In, Sn, Sb, Al, Bi, Mg, Ca, Na, K, Rb, Sr, Cs, Ba, Ce, Eu, Y, Zr, or a combination thereof.
56. The composite material, the use, the method, the cell, the battery, the process of any one of the preceding Embodiments, wherein said at least one metal material is Fe, Co, Ni, or a combination thereof.
57. The composite material, the use, the method, the cell, the battery, the process of any one of the preceding Embodiments, wherein said at least one carbon material is an N-doped carbon.
58. The composite material, the use, the method, the cell, the battery, the process of any one of the preceding Embodiments, wherein the composite material comprising at least one non-metal, non-carbon, non-hydrogen element.
59. The composite material, the use, the method, the cell, the battery, the process of any one of the preceding Embodiments, wherein the at least one non-metal, non-carbon, non-hydrogen element is at least one heteroatom.
60. The composite material, the use, the method, the cell, the battery, the process of any one of the preceding Embodiments, wherein said at least one heteroatom is one or more of N, S, B, P, O, F, Cl, Br, I, or a combination thereof.
61. The composite material, the use, the method, the cell, the battery, the process of any one of the preceding Embodiments, wherein said at least one carbon source is at least one polycyclic aromatic hydrocarbon (PAH) or a derivative thereof, a polymer, a small molecule precursor or a combination thereof.
62. The composite material, the use, the method, the cell, the battery, the process of any one of the preceding Embodiments, wherein said at least one PAH source is at least one of naphthalene, anthracene, phenanthrene, fluorene, tetracene, triphenylene, pyrene, pentacene, perylene, and fluoranthene.
63. The composite material, the use, the method, the cell, the battery, the process of any one of the preceding Embodiments, wherein said at least one PAH source is or comprises pyrene.
64. The composite material, the use, the method, the cell, the battery, the process of any one of the preceding Embodiments, wherein said at least one PAH source is a PAH derivative comprising at least one heteroatom.
65. The composite material, the use, the method, the cell, the battery, the process of any one of the preceding Embodiments, wherein said at least one PAH derivative is one or more of 1,10-phenanthroline and/or phenazine.
66. The composite material, the use, the method, the cell, the battery, the process of any one of the preceding Embodiments, wherein said at least one carbon source is one or more of benzoguanamine, guanidine thiocyanate, phenylboronic acid, hexachlorocyclotriphosphazene, borazine, triphenylamine, triphenylphospine, triphenylborane, diphenyl sulfide, thiophenes or a combination thereof.
67. The cell, the battery of any one of the preceding Embodiments, wherein said working electrode is a carbon electrode, a glassy carbon electrode, a carbon paper electrode, a gas-diffusion-layer (GDL) carbon sheet, carbon cloth, carbon foam, Ni-foam.
68. The cell, the battery of any one of the preceding Embodiments, wherein said counter electrode is or comprises platinum (Pt), zinc (Zn), Ni-foam.
69. The cell, the battery of any one of the preceding Embodiments, wherein said working electrode is one of a stationary electrode, a rotating disk electrode (RDE), or a rotating ring-disk electrode (RRDE).
70. The cell, the battery of any one of the preceding Embodiments, wherein the counter electrode is or comprises zinc (Zn), iron (Fe), aluminum (Al) tin (Sn), calcium (Ca) or a combination thereof.
71. The cell, the battery of any one of the preceding Embodiments, wherein the counter counter electrode is or comprises Zn.
72. The cell, the battery of any one of the preceding Embodiments, wherein said working electrode is positioned in a first compartment and said counter electrode is positioned in a second compartment, wherein said first compartment and said second compartment are partitioned by a membrane.
73. The cell, the battery of any one of the preceding Embodiments, wherein said membrane is an anion exchange membrane (AEM).
74. The composite material, the cell, the battery of any one of the preceding Embodiments, for use in generating oxygen.
75. The composite material, the cell, the battery of any one of the preceding Embodiments, for use in generating hydrogen peroxide (H₂O₂) or HO₂⁻.
76. The composite material, the cell, the battery of any one of the preceding Embodiments, for use as a flow-cell.
77. The composite material, the cell, the battery of any one of the preceding Embodiments, for use as a rechargeable battery.
78. The composite material, the cell, the battery of any one of the preceding Embodiments, for use as a rechargeable metal-peroxide battery.
79. The composite material, the cell, the battery of any one of the preceding Embodiments, for use in generating hydrogen gas.
80. The composite material, the cell, the battery of any one of the preceding Embodiments, for use as a hydrogen peroxide sensor.
81. The composite material, the cell, the battery of any one of the preceding Embodiments, for use in generating ammonia.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIGS. 1A-1D are X-ray diffraction (XRD) patterns and images showing structural and morphological analyses of N-doped mesoporous carbon material (NdC) prepared from 1,10-phenanthroline (PheN) using SiO₂ template synthesis (SiO₂/PheN),

FIG. 1A XRD pattern, FIG. 1B scanning electron microscopy (SEM) and energy-dispersive X-ray spectroscopy (EDS) mapping of the corresponding image (C, N, Si elemental maps), FIG. 1C high resolution transmission electron microscopy (HRTEM) image, FIG. 1D high-angle annular dark-field imaging—scanning transmission electron microscopy (HAADF-STEM) image.

FIGS. 2A-2B are characterization of NiₓPy composites, FIG. 2A Raman spectra and FIG. 2B XRD patterns of NiₓPy catalysts prepared using various amounts of Ni(NO₃)₂ precursor in molten mixture (5≤x≤40), x denotes the weight percent of only Ni out of all starting precursors (nickel nitrate salt and the pyrene (Py) PAH); reference literature diffraction patterns from the crystallography open database (COD, listed values according to X-ray wavelength of 1.540598 Å) are: cubic Ni #96-432-0487 (2θ=44.510, 51.87°, 76.41°), cubic NiO #96-101-0382 (2θ=37.32°, 43.36°, 63.00°, 75.56°, 79.57°) and hexagonal graphite 2H #96-120-0018 (2θ=26.23°).

FIGS. 3A-3P relate to characterizations of NiₓPy composite material comprising x % Ni (wt. %, that is x stands for weight ratio between Ni atoms of the precursor salt to the total reactants mass (the nickel salt+pyrene) in the starting precursors mixture) in pyrene-based composite material and, FIG. 3A-FIG. 3F relate to Ni₂₀Py, FIG. 3A high-resolution scanning electron microscopy (HRSEM), FIG. 3B high resolution transmission electron microscopy (HRTEM), FIG. 3C combined energy-filtered TEM images (EFTEM) image of FIG. 3D carbon, FIG. 3E nickel, and FIG. 3F oxygen, FIG. 3G-FIG. 3P relate to NiₓPy composite, FIG. 3G-FIG. 3K HRSEM characterization of various composites, FIG. 3L-FIG. 3P are energy-dispersive X-ray spectroscopy (EDS) elemental spectra.

FIGS. 4A-4B are X-ray photoelectron spectroscopy (XPS) data showing characterization of NiₓPy composites before and after etching (surface and within the material, respectively): FIG. 4A Ni 2p, and FIG. 4B O 1s.

FIGS. 5A-5C relate to electrochemical properties of different metal-carbon composites, where the carbon source is pyrene and the metal source is the nitrate salt of Ni, Fe, or Co; FIG. 5A are linear sweep voltammetry (LSV) curves, FIG. 5B are electron transfer number (n) at different potentials, and FIG. 5C are H₂O₂ production selectivity at different potentials, of M/C materials with M=Ni (red), Fe (black), and Co (blue).

FIG. 6 relates to measurement of the collection efficiency (N) of the rotating ring-disk electrode (RRDE) where the RRDE was placed in a 0.5 M KOH electrolyte solution containing 5 mM of K₃Fe(CN)₆ and chronoamperometry was performed at −0.3 V (vs. Ag/AgCl (3 M KCl)) while the ring potential was set at 0.5 V (vs. Ag/AgCl, 3 M KCl) for 30 min with a rotation rate of 1600 rpm.

FIGS. 7A-7C are evaluation of oxygen reduction reaction (ORR) electrocatalysis of NiₓPy via voltammetry using a RRDE in an O₂-saturated 1 M KOH, FIG. 7A relates to LSV curves of a current measured for NiₓPy-coated disk showing comparison of the ORR performance at 1600 rpm on the disc electrode (solid lines represent the disc current, I_{disk}) with the simultaneous ring-electrode current densities (dashed lines, I_{ring}) due to peroxide formation on the NiₓPy catalyst (in O₂-saturated 0.5 M KOH aqueous electrolyte) using RRDE of x=5%, 10%, 20%, 30% or 40%, FIG. 7B Calculated values of apparent electron transfer number (n) at different potentials and FIG. 7C NₓPy selectivity towards peroxide at different potentials.

FIGS. 8A-8B relate to RRDE analysis, FIG. 8A RRDE polarization curves of the Ni₂₀Py catalyst at different rotation rates (ω=100, 400, 900, 1600, 2500, and 3600 rpm) and FIG. 8 B is a Tafel plot of Ni₂₀Py.

FIGS. 9A-9D relate to RRDE durability of Ni₂₀Py where all the experiments were performed in an O₂-saturated 0.5 M KOH aqueous solution, FIG. 9A RRDE stability measurement with the disk potential fixed at 0.6 V vs. reversible hydrogen electrode (RHE) and the ring potential fixed at 1.0 V vs. RHE at 1600 rpm, FIG. 9B stability measurement with the disk potential fixed at 0.6 V vs. RHE, FIG. 9C comparison of linear sweep voltammetry profiles before and after a 100 h stability test showing the disc current and ring current and FIG. 9D comparison of selectivity towards peroxide before and after a 100 h stability test at 0.6 V vs. RHE.

FIGS. 10A-10C relate to structural and chemical characterization of Ni₂₀Py coated on carbon paper: initial conditions and after 100 h of operation, FIG. 10A Raman spectra, FIG. 10B XRD patterns, and FIG. 10C Ni 2p, O 1s, and C is X-ray photoelectron spectroscopy (XPS) spectra.

FIGS. 11A-11B Morphological analysis of Ni₂₀Py catalyst coated on carbon paper during the initial cycle and after 100 h, FIG. 11A HRSEM image during the initial cycle and FIG. 11B HRSEM image after 100 h.

FIGS. 12A-12C relate to the reversible pathway of 2e⁻ oxygen reduction reaction (ORR) and POR peroxide oxidation reaction (POR) process, FIG. 12A attenuated total reflectance Fourier-transform infrared (ATR-FTIR) measurements under various potentials (relative to RHE) for the Ni₂₀Py during ORR process, FIG. 12B schematic representation of the reversible mechanistic pathway of ORR and POR on the surface of a bifunctional catalyst, and FIG. 12C the experimental setup of in situ ATR-FTIR spectroelectrochemical measurements.

FIGS. 13A-13B represent schematic representation of density functional theory (DFT)-optimized NiO structures showing a model of a FIG. 13A NiO and FIG. 13B NiO+hydroxyl.

FIG. 14 relates to the adsorption energies and atomic configurations obtained for the most stable configuration of H₂O₂, oxygen, and O+H₂O.

FIGS. 15A-15D relate to adsorption kinetics of oxygen and water over the surfaces of FIGS. 15A-15B NiO and FIGS. 15C-15D NiO+OH representing the selected atomic configuration of the top surface achieved along with the relaxation where dashed circles present the initial and final relaxed configuration of the corresponding moieties, calculated using DFT.

FIGS. 16A-16E relate to time-of-flight secondary ion mass spectroscopy (ToF-SIMS) analysis of Ni₂₀Py and isotopic comparison for fragment peaks of NiN₃⁻, NiNCO⁻, and (or) NiC₂OH₂⁻ consisting of FIG. 16A ⁶⁰Ni and FIG. 16B ⁵⁸Ni, FIG. 16C peak assigned to ⁵⁸NiN₂C₂⁻ or ⁵⁸NiOC₃⁻, FIG. 16D concluding bar chart of normalized relative abundance of Ni fragments in a “Fresh” Ni₂₀Py electrocatalyst (left columns) and after 1000 h operation, “Post 1000 h” (right columns) and FIG. 16E N 1s XPS analysis of Ni₂₀Py.

FIGS. 17A-17B are the catalyst tolerance to 5 mM H₂O₂, FIG. 17A linear sweep voltammetry (LSV) curves, and FIG. 17B Chronoamperometry (CA) scan of RRDE at different potentials.

FIG. 18 is comparison of the peroxide oxidation reaction (POR) activity (linear sweep voltammetry profile) of Ni₂₀Py and Ni-foam (NF) in 0.5 M KOH aqueous electrolyte containing 0.1 M HO₂⁻. The low-potential part shows also the peroxide reduction reaction (PRR).

FIGS. 19A-19D relate to electrochemical ORR. FIG. 19A H-cell for H₂O₂ formation from oxygen in an aqueous alkaline medium, FIG. 19B LSV curves marking the performance of different catalyst loading in the H-cell, FIG. 19C chronoamperometry (CA) scan at 0.6 V in the H-cell configuration, and FIG. 19D H₂O₂ evolution and the corresponding Faradaic efficiency (FE) for the CA scan.

FIG. 20 is a custom-made flow-cell (gas-diffusion-layer (GDL) setup).

FIGS. 21A-21C relate to LSV curves, FIG. 21A comparison between the activity of the GDL setup and RRDE, FIG. 21B GDL in Ar and O₂, and FIG. 21C CA at different potentials for 9 h.

FIGS. 22A-22C relate to peroxide production. FIG. 22A CA of GDL setup at 0.6 V for 120 h, FIG. 22B H₂O₂ production rate at different currents and the corresponding FE, and FIG. 22C accumulated H₂O₂ and the corresponding FE at a constant 0.6 V voltage in the GDL setup.

FIGS. 23A-23E relate to HO₂⁻ concentration in the electrolyte, measured by titration with a standard Ce(SO₄)₂ solution. FIG. 23A ultraviolet-visible (UV-vis) absorbance spectra of titrant Ce(SO₄)₂ solutions to which a certain volume of HO₂⁻ solutions was added, FIG. 23B calibration curve between the absorbance at 319 nm and the peroxide concentration ([HO₂⁻]), FIG. 23C stability measurement of Ni₂₀Py under a constant voltage of 0.6 V for producing HO₂⁻ in the H-cell electrolytic device, FIG. 23D UV-vis absorption spectra of titrant Ce(SO₄)₂ solutions to which was added a certain volume of the electrolyte at different time intervals in the H-cell electrolytic device, FIG. 23E concentration of HO₂⁻ produced by Ni₂₀Py as a function of electrolysis time in 0.5 M KOH aqueous electrolyte using the H-cell electrolytic device (left) under a constant voltage of 0.6 V vs. RHE, and HO₂⁻ Faradaic efficiency as a function of electrolysis time (right).

FIG. 24 is performance metrics of the customized H-cell electrolytic device showing the rate profile of HO₂⁻ production and the corresponding Faradaic efficiency on Ni₂₀Py/carbon at various voltages (catalyst loading: ~1.0 mg cm⁻²).

FIG. 25 is durability of the H-cell electrolytic device showing the HO₂⁻ yield along with reaction time in the H-cell electrolytic device under a constant potential at 0.6 V vs. RHE and corresponding Faradaic efficiency where the error bars represent the standard deviation of experimental yield.

FIG. 26A-26F relate to FIG. 26A cyclic voltammetry (CV) curve with and without 2 mM H₂O₂, FIG. 26B CV curves at different concentrations of H₂O₂ (inset: linear relationship between iₐ and the H₂O₂ concentration), FIG. 26C LSV curves with 10 mM H₂O₂ at different scan rates, FIG. 26D Randles-Sevcik plot, FIG. 26E logarithmic plot of the current density at different scan rates, and FIG. 26F LSV curves at different RDE rotation speeds (inset: electron transfer number analysis).

FIG. 27A-27C are FIG. 27A Nyquist plots at 1.2 V with and without 10 mM H₂O₂ (inset: low Z values with the corresponding calculated R_{ct} values and the equivalent circuit used for fitting), FIG. 27B CA scan at 1.1 V vs. RHE, and FIG. 27C Tafel plot.

FIGS. 28A-28C relate to FIG. 28A scheme of a H₂O₂ electrolyzer, FIG. 28B CP scan at 10 mA cm⁻² at 1 M KOH with 0.1 M H₂O₂ and the corresponding FE for H₂ production, and FIG. 28C operando ATR-FTIR spectra at different potentials (measurement system was depicted in FIG. 12C).

FIGS. 29A-29B relate to FIG. 29A scheme of a H₂O₂ electrolyzer in a flow cell mode and FIG. 29B CP scan at 50 mA cm⁻² at 1 M KOH with 0.3 M H₂O₂ and the corresponding FE for H₂ production.

FIG. 30 is a schematic representation of a metal-peroxide (M₂-H₂O₂) battery in accordance with some examples of the disclosure.

FIG. 31 shows schematic representation of the proposed rechargeable zinc-peroxide (ZPB) battery design; the device is in a two-electrode configuration, where in the charge process Zn²⁺(aq) is reduced to Zn(s) and HO₂⁻ is oxidized to O₂(g), while in the discharge Zn(s) (i.e., the Zn anode) is oxidized to Zn²⁺ (aq) and O₂(g) is reduced to HO₂⁻ (aq) (i.e., on the surface of the bifunctional air cathode).

FIGS. 32A-32E are FIG. 32A complete CV curves of anodic and cathodic half-cell of Zn—H₂O₂ battery, FIG. 32B E-i polarization curve of Zn—H₂O₂ battery combined with power density for each point, and FIG. 32C galvanostatic charge-discharge rate profiles of ZPB in a capacity fixed mode (20 mAh cm⁻²) at different current densities (mA cm⁻²), FIG. 32D a plot of energy efficiency (q) vs. current densities and FIG. 32E charge and discharge polarization curves (E vs. j) of a rechargeable ZPB.

FIG. 33 is a galvanostatic charge-discharge rate profiles of the zinc-peroxide battery (ZPB) in a fixed capacity mode (20 mAh cm⁻²) at different current densities (mA cm⁻²).

FIGS. 34A-34B relate to comparative performance measurements of rechargeable ZPB in the presence and absence of Ni₂₀Py catalyst on carbon cathode electrode, FIG. 34A charge and discharge polarization curves (E vs. j), and FIG. 34B is galvanostatic charge-discharge profiles of ZPB at a constant capacity (25 mAh cm⁻²).

FIGS. 35A-35D relate to durability study of the rechargeable ZPB, and cycling performance of two-electrode Zn—O₂ battery using Ni₂₀Py as the catalyst of a bifunctional air electrode FIG. 35A at a capacity of 50 mAh cm⁻² (j=10 mA cm⁻²) and FIG. 35B 25 mAh cm⁻² (j=5 mA cm⁻²) in a sealed battery setup with a sufficient amount of oxygen (~0.5 mmol of 02) using 10 h charge-discharge cycles where the energy efficiency corresponds to the ratio between the charge and discharge voltage plateaus (the magnified inset in panel a shows the data between 700 and 750 h), FIG. 35C cycling performance of the two-electrode ZPB at a capacity of 15 mAh cm⁻² (j=3 mA cm⁻²) (the magnified inset in panel c shows the data between 650 h and 700 h), FIG. 35D discharge-charge profile at a rate of 50 mAh cm⁻² (complete line; left y-axis scale) and the accompanying changes in HO₂⁻ concentration (circles show the measurements, with a dashed connecting line serving as a guide to the eye; right y-axis scale).

FIGS. 36A-36E refer to structural analysis of the Ni₂₀Py air cathode before and after operation (1000 h). HRSEM images of the Ni₂₀Py electrode after: FIG. 36A 100 h (10 cycles), FIG. 36B 500 h (50 cycles), and FIG. 36C 1000 h (100 cycles); FIG. 36D Ni 2p, 0 Is, and C is XPS spectra, and FIG. 36E Raman spectra.

FIG. 37 refers to CO₂ quantification during the ZPB battery test showing the amount of measured CO₂ in the cathodic compartment during the battery test at a fixed capacity of 50 mAh cm⁻² via gas chromatography quantification.

FIG. 38 refers to polarization curves of a ZPB cell in a two-electrode configuration with atmospheric air.

FIGS. 39A-39E refer to FIG. 39A XRD patterns of Ni₃₀PyrₓPPh_{3 100-X} (x=100, 75, 50, 25, 0), SEM images of FIG. 39B Ni₃₀PPh₃ and FIG. 39C Ni₃₀PyrPPh₃, FIG. 39D and FIG. 39E are HRTEM images of Ni₃₀PyrPPh₃.

FIGS. 40A-40B refer to crystallographic investigation of different transition-metal phosphides (TMPs) and XRD patterns of the final products of different transition-metal phosphides using 30 wt. % total metal in 1:1 mass ratio of pyrene and PPh₃ melt, FIG. 40A unary phosphides (M=Ni, Co, Fe, Cu) and FIG. 40B binary phosphides (Fe—Ni, Ni—Co 1:1 mass ratio mixtures), in this case a binary Ni—Fe phosphide is formed while in the Ni—Co case, a mixture of two unary phosphides is formed.

FIGS. 41A-41B refer to the investigation of TMPs loaded on carbon cloth (0.5 mg cm⁻²) activity towards electrochemical nitrate reduction, FIG. 41A LSV (linear sweep voltammetry) current density vs. potential of Co₂P, Fe₃P, CusP, and Ni₃P electrocatalysts in the cathodic region and FIG. 41B performance comparison of NH₃ production rate for (r_{NH3}) unary TMPs (up to 20 C cumulative charge chronoamperometry experiments at 10 mA cm⁻² (E vs. RHE for each catalyst is indicated in the legend) showing achieved Faradaic efficiencies (FE)s towards NH₃ synthesis: Co₂P=95%, Fe₃P=71%, Cu₃P=58%, Ni₃P=13%, and pristine carbon cloth=23%.

### DETAILED DESCRIPTION OF EMBODIMENTS

The development of electrochemical energy conversion and storage devices (e.g., metal-air batteries, valuable chemicals, and chemical fuel production) offers new opportunities to address global energy challenges.

The present disclosure is based on the development of composite materials that exhibit unique properties including ability to support both oxidation reactions and reduction reactions. Based on these properties, it was suggested that the composite material may be considered as a bifunctional material exhibiting activity in oxidation reactions and in reduction reactions.

As shown in the examples below, it was surprisingly found that the composite material may uniquely affect oxygen reduction reaction (ORR) such that the reaction selectively proceeds via a two-electrons (2e⁻) transfer process (i.e., not a four-electron transfer reaction) such that reduction of oxygen generates hydrogen peroxide or a peroxide anion thereof (HO₂⁻). This suggested that the composite material is characterized by a unique high selectivity during ORR, affecting/driving the ORR towards selective generation of hydrogen peroxide or a peroxide anion.

It was also surprisingly found that the composite material may affect peroxide oxidation reaction (POR) by oxidizing hydrogen peroxide or a peroxide anion to generate oxygen.

In addition, it was surprisingly found that the same composite material reversibly enables ORR and POR, such that during ORR, oxygen is reduced to hydrogen peroxide or peroxide anion and during POR hydrogen peroxide or peroxide anion is oxidized to oxygen. As described, due to the bi-functionally characteristics of the composite material, the composite material may affect both reactions and at times even in a reversible manner.

Based on the above, it was suggested that the composite material may be applicable in various electrochemical applications including, inter alia, hydrogen peroxide production, electrolyzer, and rechargeable battery as further described herein below.

In accordance with some aspects, the present disclosure provides a composite material for electrocatalysis in ORR. In accordance with some aspects, the present disclosure provides a composite material for electrocatalysis in ORR to generate hydrogen peroxide or a peroxide anion thereof (HO₂⁻).

In accordance with some other aspects, the present disclosure provides a composite material for electrocatalysis in POR.

In accordance with some further aspects, the present disclosure provides a composite material for reversible electrocatalysis in ORR and POR.

As described below, the composite material comprises a metal material and a carbon material.

In accordance with some aspects, it is provided a composite material represented by a formula M-C, wherein M is at least one metal material and C is at least one carbon material, wherein the composite material serves as the electrocatalyst for an oxidation reaction, a reduction reaction, or reversible oxidation-reduction reactions.

In the following text, when referring to the composite material it is to be understood as also referring to the electrodes, electrochemical cells, battery, use, process and method disclosed herein. Thus, whenever providing a feature with reference to the composite material, it is to be understood as defining the same feature with respect to the electrodes, electrochemical cells, battery, use, process or method mutatis mutandis.

As noted above, it was shown that the composite material mediates ORR and/or POR.

Hence, in accordance with some aspects, it is provided a composite material represented by a formula M-C, wherein M is at least one metal material and C is at least one carbon material, wherein the composite material is for electrocatalysis in ORR and/or in POR.

In accordance with some aspects, it is provided a composite material represented by a formula M-C, wherein M is at least one metal material and C is at least one carbon material, wherein the composite material is for electrocatalysis in ORR.

In accordance with some aspects, it is provided a composite material represented by a formula M-C, wherein M is at least one metal material and C is at least one carbon material, wherein the composite material is for electrocatalysis in POR.

In accordance with some aspects, it is provided a composite material represented by a formula M-C, wherein M is at least one metal material and C is at least one carbon material, wherein the composite material is for electrocatalysis in ORR.

In accordance with some aspects, it is provided a composite material represented by a formula M-C, wherein M is at least one metal material and C is at least one carbon material, wherein the composite material is for reversible electrocatalysis in ORR and POR.

The composite material as used herein refers to a material made from combination of two or more distinct materials with different physical or chemical properties. The materials forming the composite material are at times referred to as phases and are combined to create a new material that at times exhibits enhanced or unique properties.

The composite material is applicable for electrocatalysis of oxidation and/or reduction as described herein. The term electrocatalysis as used herein refers to a process in which a catalyst facilitates and accelerates electrochemical reactions at the electrode-electrolyte interface.

In the context of specific electrochemical reactions, one example is the ORR, during which, oxygen molecules are reduced to water and at times to hydrogen peroxide.

The composite material described herein is characterized by unique features such that during ORR oxygen molecules are reduced to hydrogen peroxide and anions of hydrogen peroxide, peroxide anions.

In some examples, the composite material exhibits activity for the reduction of oxygen to H₂O₂ or HO₂⁻ during the ORR.

The term exhibit activity as used herein is used to describe that the composite material is capable of supporting/catalyzing the recited reaction.

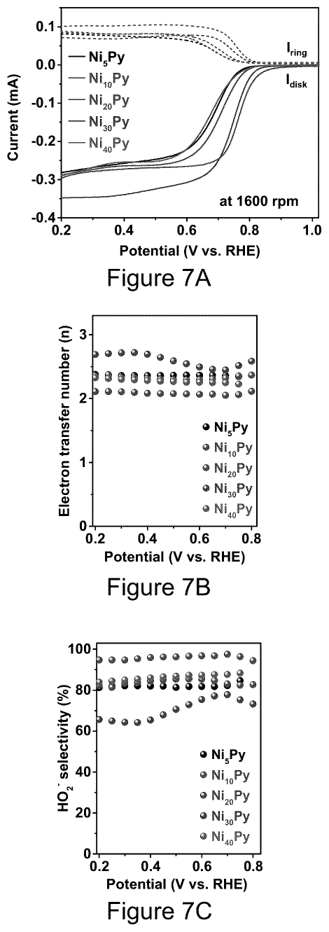

As shown in the examples below, for example, in FIGS. 7A-7C, reduction of oxygen to H₂O₂ or HO₂⁻ during ORR is highly selective. As used herein, for example in FIGS. 7A-7B, selectivity in connection with the present disclosure indicates that the ORR generates H₂O₂ or HO₂⁻ in excess over hydroxide (OH⁻ is the product of a 4e⁻ reduction of O₂ in alkaline medium).

In some examples, reduction of oxygen to H₂O₂ or HO₂⁻ during ORR is with a selectivity of at least about 80%, at times at least about 83%, at times at least about 85%, at times at least about 87%, at times at least about 90%, at times at least about 93%, at times at least about 95%, at times at least about 97% selectivity.

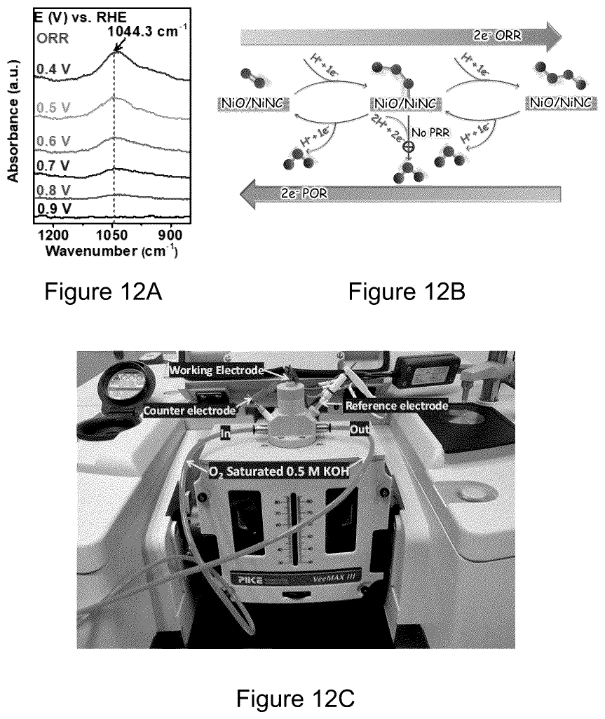

As shown for example, in FIG. 12A, the existence of OOH* as an intermediate confirms the associative 2e⁻ pathway during the ORR. A schematic representation of the mechanism is suggested in FIG. 12B.

In some examples, reduction of oxygen to H₂O₂ or HO₂⁻ involves a two-electrons transfer.

Another example of an electrochemical reaction is POR, during which, H₂O₂ or HO₂⁻ molecules are oxidized to oxygen molecules.

In some examples, the composite material exhibits activity for oxidation of H₂O₂ or HO₂⁻ to oxygen during POR.

As described herein, the composite material may activate reversible oxidation-reduction reactions.

In some examples, the composite material is configured to affect reversible reduction and oxidation.

In some examples, the composite material exhibits reversible activity of reduction during ORR and oxidation during POR.

In some examples, the composite material exhibits reversible activity for the reduction of oxygen to H₂O₂ or HO₂⁻ during the ORR and for the oxidation of H₂O₂ or HO₂⁻ to oxygen during the POR.

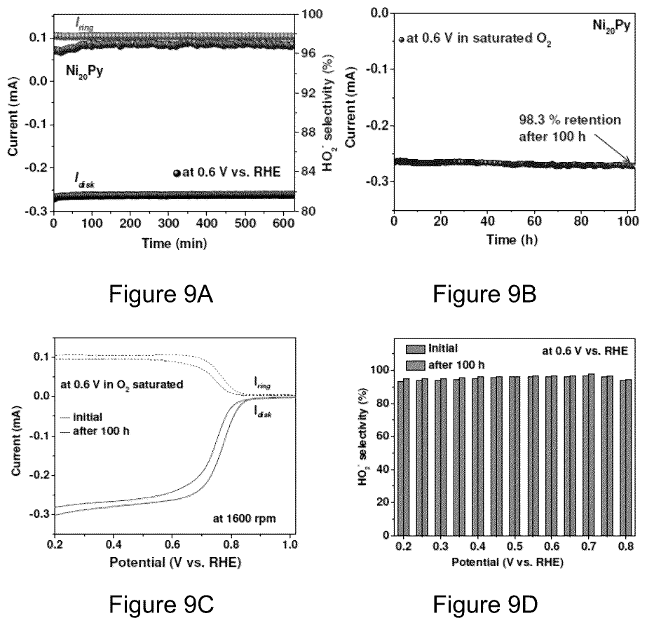

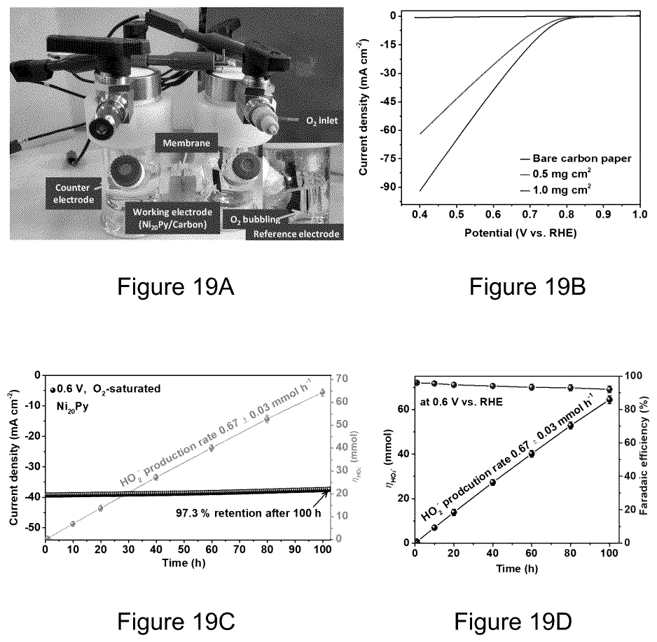

As shown, for example, in FIG. 9B or FIG. 19C below, the composite material was shown to be stable during hydrogen peroxide production after a 100 h continuous test.

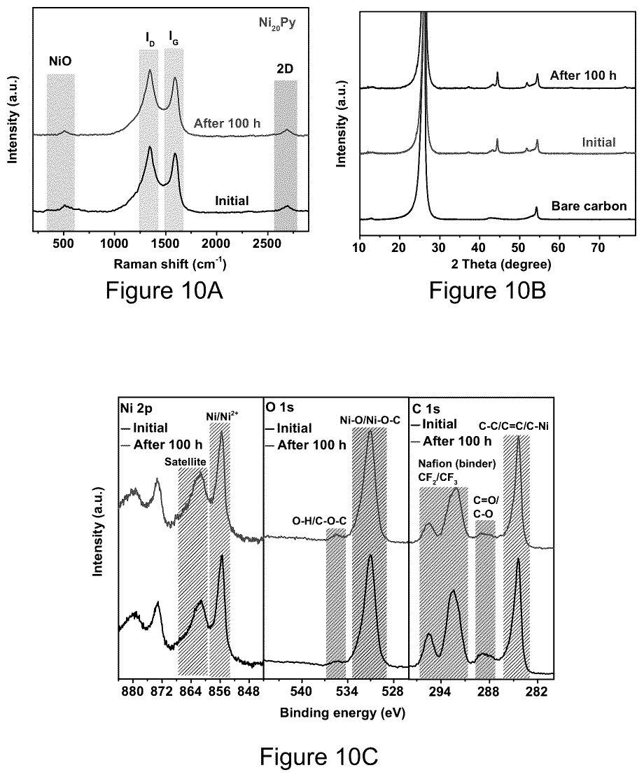

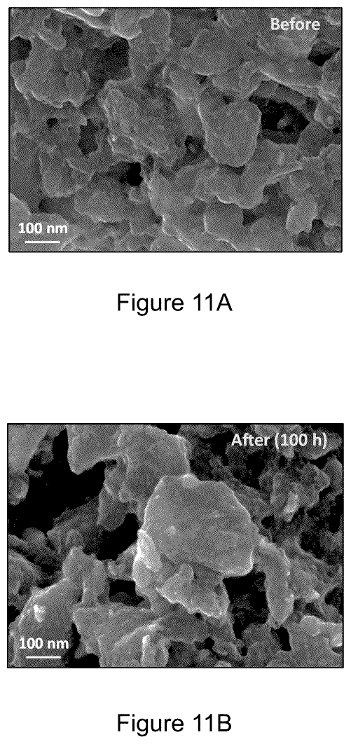

In addition, analysis by Raman spectroscopy, X-ray diffraction (XRD), X-ray photoelectron spectroscopy (XPS), and high-resolution scanning electron microscopy (HRSEM) before and post-operation as shown in FIGS. 10A-10C and 11A-11B suggest that the structural and morphological properties stay the same before and after 100 hours of continuous testing (FIG. 11B). These analyses accentuate the catalyst's stability after extensive use.

In some examples, the composite material is stable for at least 100 hours of continuous operation. The term stable or stability as used herein is used to denote that the composite material maintains functional and/or structural properties after prolonged operation times.

The composite material is not limited to a specific metal and is applicable for a variety of metals or combination thereof.

In some examples, the at least one metal material is at least one of (i) at least one alkali metal, (ii) at least one alkaline earth metal, (iii) at least one transition metal, (iv) at least one post-transition metal or (v) a combination thereof.

In some examples, the at least one metal material is at least one alkali metal.

In some examples, the at least one metal material is at least one alkali earth metal.

In some examples, the at least one metal material is at least one transition metal.

In some examples, the at least one metal material is at least one post-transition metal.

In some examples, the at least one metal material is at least one of V, Cr, Mn, Fe, Co, Ni, Cu, Zn, Mo, W, In, Sn, Sb, Al, Bi, Mg, Ca, Na, K, Rb, Sr, Cs, Ba, Ce, Eu, Y, Zr or a combination thereof.

In some examples, the at least one metal material is Ni.

In some examples, the at least one metal material is Co.

In some examples, the at least one metal material is Fe.

In some examples, the at least one metal material is Cu.

As noted herein, the composite material may comprise a single metal, two different metals or even three different or four different metals, or even more.

The composite material comprises at least one carbon material.

The term “carbon material” as used herein refers to any substance primarily composed of carbon atoms. As described below the carbon material may be synthesized from a variety of carbon sources used during preparation of the composite material.

The carbon material is at times referred herein as “carbonaceous matrix”. The term carbonaceous matrix refers to a carbon-rich material providing a matrix in which other materials, for example, composed of at least one metal atom type and/or at least one heteroatom as described herein may be at least partially embedded.

The present disclosure is not limited to a specific carbon material.

Non-limiting examples of carbon materials include but not limited to graphene, graphite, graphene quantum dots, porous carbons, activated carbons, carbon nanotubes, carbon nanofibers, fullerenes, and their derivatives.

In some examples, the carbon material in the composite material is characterized by being a graphite material with crystalline domains.

In some examples, the carbon material in the composite material is characterized by being a crystalline graphite material.

In some examples, the carbon material in the composite material is characterized by comprising multiple aromatic rings.

In some examples, the carbon material in the composite material is characterized by comprising one or more of O, N heteroatoms.

The composite material may comprise in accordance with some examples at least heteroatom (i.e. a non-carbon, non-hydrogen atom).

In some examples, the composite material comprises one or more heteroatom.

In some examples, the composite material may comprise one or more of B, O, N, S, P, F, Cl, Br, I.

In some examples, the carbon material may comprise one or more of B, O, N, S, P, F, Cl, Br, I.

The composite material may comprise varying amounts of the at least one heteroatom.

In some examples, the composite material may comprise at most 1% of a heteroatom. It should be noted that in such examples, the amount of the at least one heteroatom may be present under the detection level of a measurement system.

Without being bound by theory, it was suggested that in such examples, in which the heteroatom is present in the composite material in an amount of at most 1%, the heteroatom forms a connection with the metal and the carbon and contributes to the binding and stabilization of a peroxide anion onto the composite material.

In some examples, the composite material may comprise at least 1% of a heteroatom.

The composite material may have different morphology/structure.

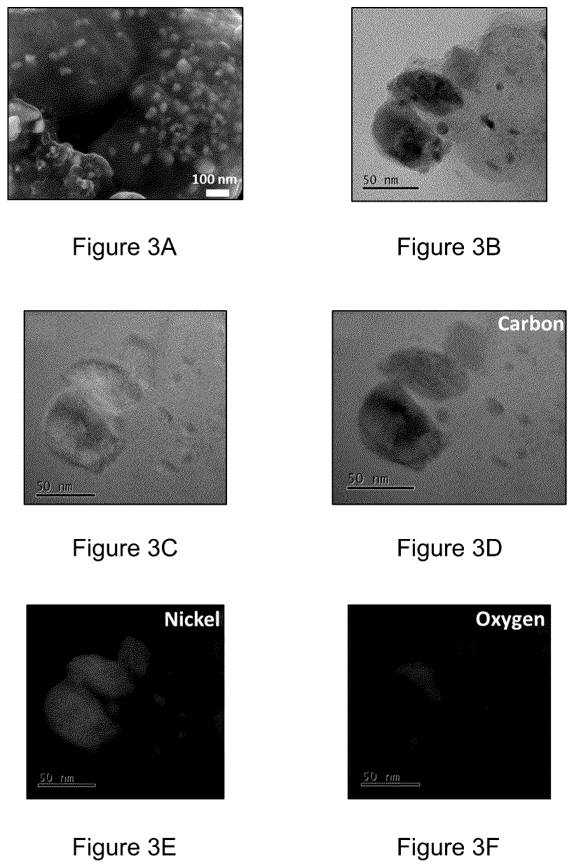

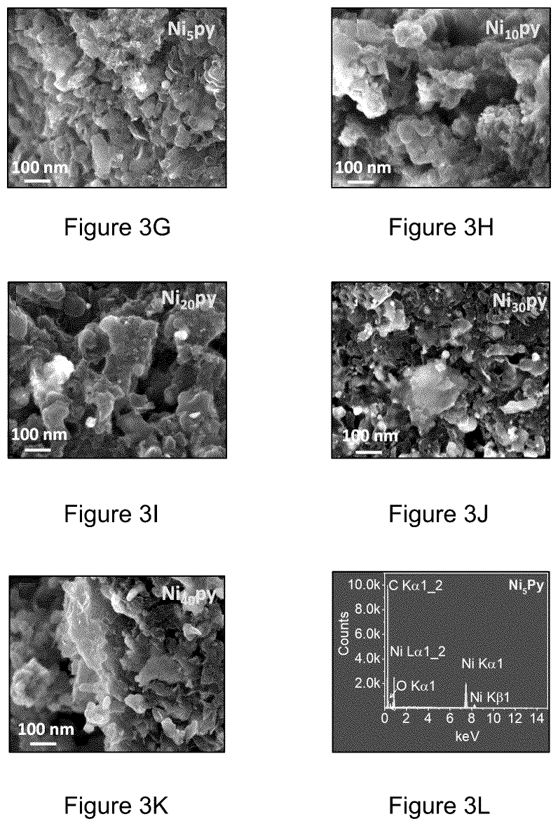

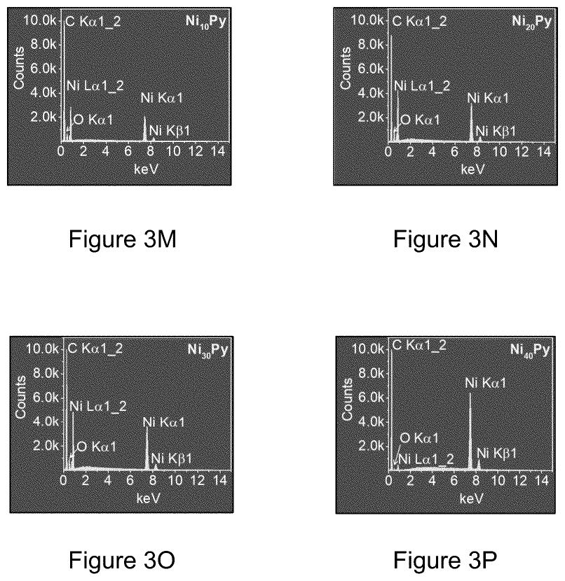

As shown in FIG. 3A, a composite material adopted a structure of metal-based nanoparticles (NPs) within a carbonaceous matrix such that the metal NPs were dispersed uniformly within the carbonaceous material. It was suggested that the microscopic structure of the composite material in the presence of a heteroatom may depend on the synthesis process.

It was suggested that each one of the carbon material and the at least one metal material are present in a different phase and hence referred herein at times as M/C with the “/” denoting the interface between two adjacent solid phases. As appropriated, M refers to one or more metals and hence in some examples, the composite material may be referred to as M/C (for example a binary metal/carbon composite: M₁M₂/C in which n=2) In examples in which the composite material comprises one or more heteroatoms, the source of the heteroatom as one of the reactants in the process for preparing the composite material may affect/determine the distribution, structure configuration in the composite material.

In some examples in which the composite material comprises one or more heteroatoms, the composite material may be characterized as MX/C.

“M/CX” as used herein refers to a metal-incorporated carbon matrix, possibly with heteroatom modification of the carbon matrix, CX of stoichiometric composition CX_{y}.

In some examples, in which the composite material is represented as M/CX, the carbon atom may be chemically connected to the at least one heteroatom. In some examples, in which the composite material is represented as M/CX, the carbon atom may be covalently connected to the at least one heteroatom. In some examples, in which the composite material is represented as M/CX, the carbon atom may be connected to the at least one heteroatom by non-covalent interactions.

Formation of M/CX may be shown for example in example 1 below in N-doped carbon.

In some examples in which the composite material comprises one or more heteroatoms, the composite material may be characterized as M/CX “MX/C” as used herein refers to a (partial or full) replacement of the metal M with a metal-heteroatom compound, MX of stoichiometric composition MX_{y}.

In some examples, in which the composite material is represented as MX/C, the metal atom may be chemically bound to the at least one heteroatom. In some examples, in which the composite material is represented as MX/C, the metal atom may be connected to the at least one heteroatom by a non-covalent interaction. In some examples, in which the composite material is represented as MX/C, the metal atom may be connected to the at least one heteroatom by a covalent interaction.

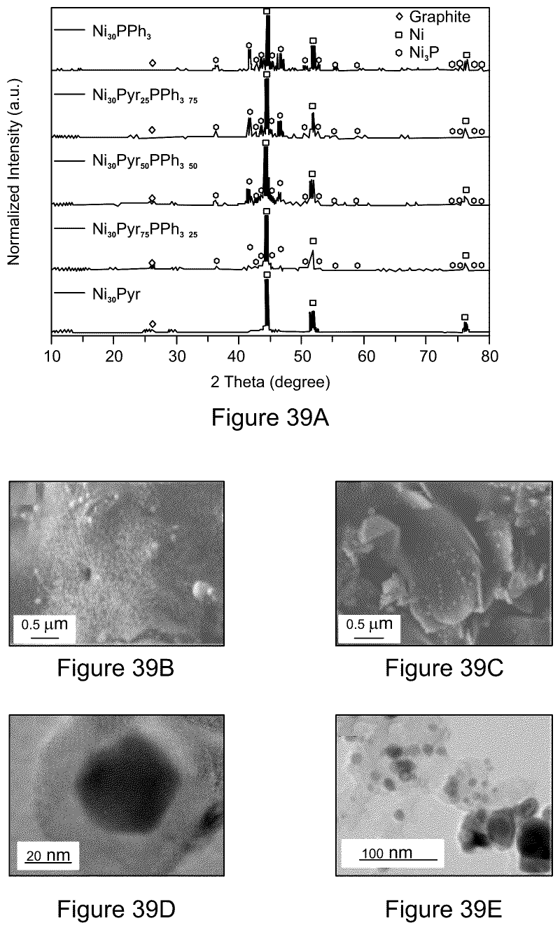

As shown in FIG. 39, composite materials synthesized from at least one metal source, pyrene (Pyr) as the PAH, and triphenylphosphine (PPh₃) show apparent morphological differences as compared to composite materials synthesized from at least one metal source and PPh₃.

As shown in this Figure, the latter (composite materials synthesized from at least one metal source and PPh₃) showed a uniformly distributed Ni₃P nanoparticles on a bulk carbon particle.

In contrast, the former (materials synthesized from at least one metal source, Pyr and triphenylphosphine PPh₃) shows petal-like bulk carbon particles with Ni₃P nanoparticles on their sharp edges.

Without being bound by theory, it was suggested that the heteroatom (for example P) interacts with the metal during synthesis and forms one or more metal-heteroatom compounds (for example MP_{y}). These heteroatom-metal compounds are at least partially embedded within the carbonaceous matrix in addition or instead of a metal compound.

The composite material described herein may be synthesized by the synthetic processes described in the examples below.

In accordance with some aspects, the present disclosure provides a process comprising mixing at least one metal source with at least one carbon source under conditions allowing formation of a molten mixture of the metal and carbon sources.

In some examples, the process comprising sequential heating steps. In some examples, each heating step is at a different temperature.

In some examples, the process comprises heating at a first temperature of at most 100° C.

It was suggested that this step may be used to evaporate water and/or impurities adsorbed to the surface of the carbon source and/or metal source.

In some examples, the conditions comprise heating at a first temperature of at most 100° C. for a time sufficient to evaporate water and/or impurities adsorbed to the surface of the carbon source and/or metal source.

In some examples, the process comprises heating at a first temperature of at most 100° C. for about 1 hour.

In some examples, the process comprising heating at a second temperature that is above the melting temperature of the at least one metal source and the at least one carbon source. It was suggested that heating at the second temperature forms a molten-state intermediate, enabling a homogeneous distribution of elements. In was further suggested that heating at the second temperature allows evaporation of water and/or impurities bound within the carbon source and/or metal source.

In some examples, the process comprising heating at a second temperature of at least about 100° C. In some examples, the process comprising heating at a second temperature of at most about 500° C. In some examples, the process comprising heating at a second temperature of between about 100° C. and about 500° C. In some examples, the process comprising heating at a second temperature of about 120° C., at times about 150° C., at times about 170° C., at times about 200° C., at times about 230° C., at times about 250° C., at times about 270° C., at times about 300° C., at times about 350° C., at times about 400° C., at times about 450° C., at times about 500° C.

In some examples, the process comprising heating at a second temperature for about 1 hour.

In some examples, the process comprising heating at a third temperature of at least about 500° C., at times at least about 600° C., at times at least about 700° C., at times at least about 800° C., at times at least about 900° C., at times at least about 1000° C.

In some examples, the process comprising heating at a third temperature for at least 2 hours.

In some examples, the metal source may be a metal salt or a metal salt hydrate.

As further described below, different carbon sources may be used in the synthesis of the composite material.

In some examples, the at least one carbon source comprises one or more aromatic rings. In some examples, the at least one source comprises at least two aromatic rings.

In some examples, the at least one carbon source comprises two aromatic rings, at times three aromatic rings, at times four aromatic rings, at times five aromatic rings, at times six aromatic rings, at times seven aromatic rings, at times eight aromatic rings, at times nine aromatic rings. In some examples, the at least one carbon source comprises more than nine aromatic rings.

In some examples, the at least one carbon source is at least one polycyclic aromatic hydrocarbon (PAH) or an analogue thereof.

PAH refers to a class of organic compounds that is composed of multiple aromatic rings.

In some examples, the PAH comprises two aromatic rings, at times three aromatic rings, at times four aromatic rings, at times five aromatic rings, at times six aromatic rings, at times seven aromatic rings or more.

In some examples, the PAH is a light PAH. Light PAH refer to PAH with up to four rings. In some examples, the PAH is a heavy PAH. Heavy PAH refer to PAH with more than four rings.

In some examples, the at least one PAH is at least one of naphthalene, anthracene, phenanthrene, fluorene, tetracene, triphenylene, pyrene, pentacene, perylene, and fluoranthene.

In some examples, the at least one PAH is or comprises pyrene.

As described herein, the composite material may comprise at least one heteroatom.

In some examples, the source of the heteroatom is from a salt. The salt may be a hydrate or anhydrous. In cases in which the heteroatom is from a salt, it may be considered such that the salt is a salt of the metal in the composite material. In such examples in which the heteroatom source is the metal salt, it was suggested that the amount of the heteroatom is at most 1%. In such examples in which the heteroatom source is the metal (M) salt being the source of the M in the composite M/C material, it was suggested that the amount of the heteroatom is at most 1%.

Alternatively or additionally, the source of an heteroatom may be from a carbon source containing a heteroatom. The carbon source containing a heteroatom may be considered as comprising at least one heteroatom covalently bound to at least one carbon atoms.

The carbon source containing heteroatom may be from a modification of PAH. For example, a sulfide-, a sulfone-, a nitrogen, a carboxylic acid-substituted PAH. In some examples, the at least one carbon source is at least one PAH analogue. As used herein the term PAH analogue refers to PAH comprising one or more heteroatom. As noted above, a heteroatom, can be one or more of the following: B, O, N, S, P, F, Cl, Br, I.

In some examples, the at least one PAH analogue is or comprises 1,10-phenanthroline (PheN).

In some examples, the carbon source containing heteroatom is a small molecule. In some examples, the small molecule is one or more of benzoguanamine, guanidine thiocyanate, phenylboronic acid, hexachlorocyclotriphosphazene, borazine, triphenylamine, triphenylphospine, triphenylborane, diphenyl sulfide, thiophenes or a combination thereof.

In some examples, the at least one carbon source is triphenylphosphine (PPh₃). In some examples, the at least one carbon source is pyrene and PPh₃.

In some examples, the carbon source containing heteroatom is a low-molecular weight polymer. As described herein, in some embodiments in which the composite material comprises one or more heteroatoms, such heteroatoms may be derived from the at least one PAH analogue or alternatively other sources of heteroatoms that may be added during synthesis of the composite material.

As shown in Example 1, composite material may comprise N-doped carbon material (NdC) by using N-containing modified PAH as one of the reactants.

N-doped carbon materials (NdC) as used herein refers to carbon-based materials that have been doped with nitrogen (N). As shown herein, the NdC possess a mesoporous structure.

As described in the examples below, micro/mesoporous heteroatom-doped/incorporated carbon materials may be prepared by forming a mixture of the carbon source described herein above and templating agents, for example, SiO₂, anodic aluminum oxide (AAO), salt melt mixtures (LiX, NaX, KX, RbX, MgX₂, CaX₂, ZnX₂, etc., where X=Cl, Br, I).

Hence, the present disclosure provides a process for the preparation of a N-doped mesoporous carbon materials (NdC), the process comprising heating at least a carbon source with at least one templating agent.

Hence, the present disclosure provides a process for the preparation of a N-doped mesoporous carbon materials (NdC), the process comprising mixing SiO₂ nanoparticles with 1,10-phenanthroline (PheN) and subjecting the mixture to subsequent heating.

Hence, the present disclosure provides a process for the preparation of a N-doped mesoporous carbon materials (NdC), the process comprising subjecting a mixture of SiO₂ nanoparticles with 1,10-phenanthroline (PheN) to subsequent heating steps and removing the SiO₂.

In some examples, the process comprising one heating step, at times two heating steps, at times three heating steps.

In some examples, the process comprising a first heating step at a temperature of about 90° C. In some examples, the process comprising a first heating step at a temperature of about 90° C. for about 1 hour.

In some examples, the process comprising a second heating step at a temperature of 150° C.

In some examples, the process comprising a third heating step at a temperature of about 800° C.

In some examples, the heated mixture was allowed to cool to about 25° C.

In some examples, the cooled mixture was subjected to a basic solution.

Without being bound by theory, it was suggested that a composite material prepared by a process comprising preparation of N-doped carbon materials, may be characterized by having pores with sizes in the mesoscale range or micro range and hence provide a large specific surface area hence are advantages in the electrocatalytic reactions described herein, ORR and/or POR. As shown herein, the composite material may be used as an electrocatalyst.

The term electrocatalyst as used herein refers to a material that catalyzes or facilitates electrochemical reactions.

In some examples, the electrocatalyst (i.e., the composite material) may be an electrode.

In some other examples, the electrocatalyst (i.e., the composite material) may be applied as coatings or integrated into an electrode.

In some examples, the electrocatalysts may be applied as coating on an electrode.

The composite material either being an electrode or coated/integrated on an electrode can form part of an electrochemical cell. As described the electrode being or comprising the composite material has the advantage of being bi-functional and hence supporting (catalyzing, facilitating) oxidation reactions, reduction reactions, or reversible oxidation and reduction reactions.

In accordance with some aspects, it is provided an electrochemical cell comprising two or more electrodes, at least one electrode is configured to support reduction reactions, wherein the electrode is or comprising a composite material is represented by a formula M-C, wherein M is at least one metal material and C is at least one carbon material. In some examples, the composite material is represented by M/C.

In accordance with some aspects, it is provided an electrochemical cell comprising two or more electrodes, at least one electrode is configured to support reduction reactions, wherein the electrode is or comprising a composite material is represented by a formula M/C, wherein M is at least one metal material and C is at least one carbon material and wherein the reduction reaction is ORR.

In accordance with some aspects, it is provided an electrochemical cell comprising two or more electrodes, at least one electrode is configured to support oxidation reactions, wherein the electrode is or comprising a composite material is represented by a formula M-C, wherein M is at least one metal material and C is at least one carbon material. In some examples, the composite material is represented by M/C.

In accordance with some aspects, it is provided an electrochemical cell comprising two or more electrodes, at least one electrode is configured to support oxidation reactions, wherein the electrode is or comprising a composite material is represented by a formula M/C, wherein M is at least one metal material and C is at least one carbon material and wherein the oxidation reaction is POR.

In accordance with some aspects, it is provided an electrochemical cell comprising two or more electrodes, at least one electrode is configured to support reversible oxidation-reduction reactions wherein the electrode is or comprising a composite material wherein the electrode is or comprising a composite material is represented by a formula M-C, wherein M is at least one metal material and C is at least one carbon material. In some examples, the composite material is represented by M/C.

In accordance with some aspects, it is provided an electrochemical cell comprising two or more electrodes, at least one electrode is configured to support reversible oxidation-reduction reactions wherein the electrode is or comprising a composite material wherein the electrode is or comprising a composite material is represented by a formula M/C, wherein M is at least one metal material and C is at least one carbon material, wherein the reduction reaction is ORR and the oxidation reaction is POR.

An electrochemical cell as used herein refers to a device capable of either generating electrical energy from chemical reactions occurring in it or using electrical energy supplied to it to facilitate chemical reactions. Cells that generate an electric current from chemical reactions are termed “Galvanic cells” or “Voltaic cells”, whereas cells which cause chemical reactions to occur when an electric current is passed through them are termed “electrolytic cells”. Electrochemical cells can be undivided (non-partitioned), or divided that is made up of two half-cells, each consisting of an electrode, which is dipped in an electrolyte. The same electrolyte can be used for both half cells. These half cells are connected by a salt bridge, which affords ionic contact between the two halves but prevents them from mixing with each other. An example of a salt bridge is a filter paper which is dipped in a potassium nitrate or sodium chloride solution. One of the half cells loses electrons due to an oxidation reaction at the surface of the immersed anode and the other gains electrons in a reduction process at the surface of the immersed cathode.

The tendency of a reactive electrode, which is in contact with an electrolyte, or a chemical species on an inert electrode to lose or gain electrons, is referred to as the “half-cell potential”. Values of these potentials are used for predicting the overall cell potential.

Generally, all potentials are measured vs. a reference electrode (an electrode of a known potential relative to the reversible hydrogen electrode (RHE) scale).

In some examples, the electrochemical cell is a primary cell. A primary cell as used herein refers to electrochemical cell in which irreversible reactions occur such that once the reactants are consumed for the generation of electrical energy, the cell stops producing an electric current. In these cells, the anode will typically be negative, or oxidation reaction will occur on its surface, and the cathode will typically be positive, or reduction reaction will occur on its surface. An example of a primary cell is a galvanic cell. Primary cells are basically use-and-throw galvanic cells.

In some examples, the electrochemical cell is a secondary cell. A secondary cell as used herein refers to a “rechargeable cell”, is an electrochemical cell, featuring reversible reactions, such as electrolytic cells.

In accordance with yet some other aspects, it is provided an electrochemical cell comprising an electrode assembly comprising a working electrode and a counter electrode, wherein the working electrode is or is at least partially coated with a composite material represented by a formula M/C, wherein M is at least one metal material and C is at least one carbon material.

In some embodiments which may be considered as aspects of the present disclosure, the electrochemical cell is for generation of hydrogen peroxide.

In some embodiments which may be considered as aspects of the present disclosure, the electrochemical cell is a flow-cell.

A flow-cell as used herein refers to an electrochemical device that converts chemical energy into electrical energy or vice versa through an electrochemical reaction in a flow apparatus.

In some examples in which the electrochemical cell is a flow-cell, the composite material is for electrocatalysis in ORR. In some examples in which the electrochemical cell is an ORR flow-cell, the composite material exhibits activity for the reduction of oxygen to H₂O₂ or HO₂⁻ during the ORR. As described herein, the reduction of oxygen to H₂O₂ or HO₂⁻ is with a selectivity of at least 90%, at times at least 93%, at times at least 95%, at times at least 97%.

In some examples in which the electrochemical cell is a flow-cell, the working electrode may act as a cathode. In some examples, the working electrode is or comprises carbon at least partially coated with the composite material. In some examples, the working electrode is a gas-diffusion-layer (GDL) carbon sheet at least partially coated with the composite material.

In some examples, in which the electrochemical cell is an ORR flow-cell, the composite material comprises at least one metal and at least one carbon material. In some examples, the at least one metal is Ni.

In some examples, in which the electrochemical cell is an ORR flow-cell, the counter electrode is platinum or a Ni-foam.

In some examples, the cell is configured to hold an aqueous solution. In some examples, the cell is configured for holding aqueous solution having a pH of above 7.

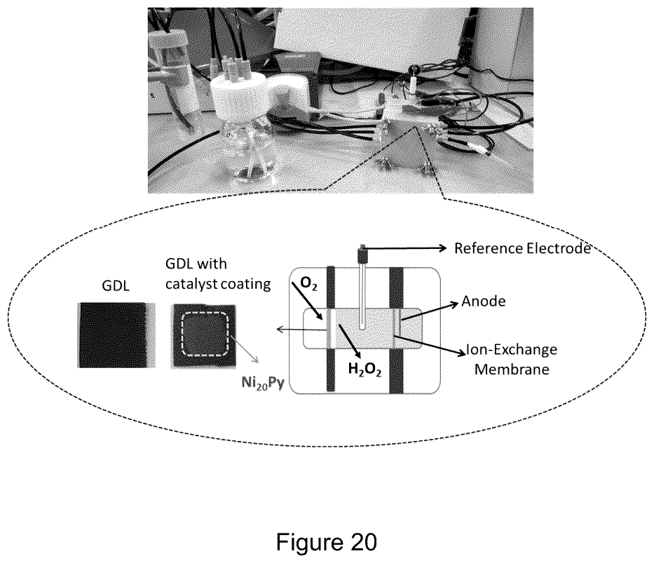

As shown in the examples below (FIG. 20), a custom-made an ORR flow-cell was constructed comprised of a Ni-foam anode separated from the cathode by an anion exchange membrane. The cathode is made of a GDL carbon sheet loaded with M/C catalyst. This setup allows operation at 18 mA cm⁻² at 0.7 V vs. RHE, and 130 mA cm⁻² at 0.3 V vs. RHE. The remarkable activity with 95% Faradaic efficiency (FE) was demonstrated for more than 120 h at 0.6 V vs. RHE (~42.0 mA cm⁻²). Under industrial-like conditions (constant voltage) production rate of 1.59±0.50 mmol h⁻¹ was maintained for at least 2 h with an average FE of 96%.

In some examples, the ORR flow-cell may be suitable for operation of at least 2 hours under an applied voltage of 0.6V.

In some embodiments which may be considered as aspects of the present disclosure, the electrochemical cell is for generating hydrogen gas.

In some embodiments which may be considered as aspects of the present disclosure, the electrochemical cell is for generating oxygen gas.

In some embodiments which may be considered as aspects of the present disclosure, the electrochemical cell is an electrolysis cell (electrolyzer).

An electrolyzer as used herein refers to a device/apparatus that uses electricity in a process called electrolysis to break water into hydrogen and concurrently to break the peroxide (HO₂⁻) into oxygen on the other electrode. Through electrolysis, the electrolyzer system creates hydrogen gas. The oxygen byproduct is released into the atmosphere or recaptured or stored to supply other industrial processes or medical needs. For example, the hydrogen generated can be used to power any hydrogen fuel-cell application.

The two half reactions may be considered as follows:

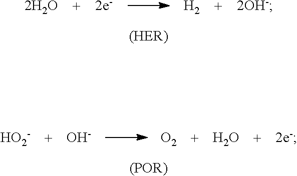

In some examples the electrolyzer operates in an H-cell configuration.

In some examples the electrolyzer operates in a flow-cell configuration.

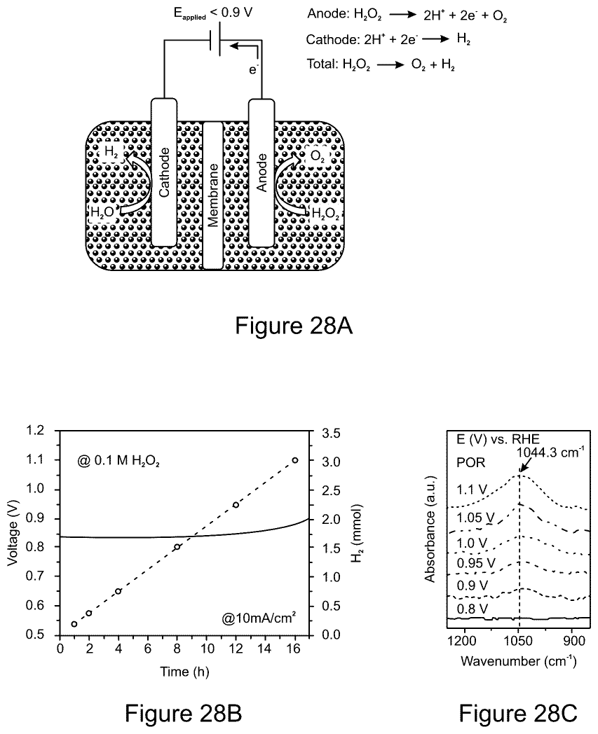

In some examples, for example in FIG. 28A, in which the electrochemical cell is an electrolysis cell, the composite material is for electrocatalytic POR. In some examples (FIGS. 28B-28C) in which the electrochemical cell is an electrolysis cell, the composite material exhibits activity for the oxidation of H₂O₂ or HO₂⁻ to oxygen to during the POR.

In some examples in which the electrochemical cell is an electrolysis cell, the working electrode may act as an anode. In some examples, the working electrode is or comprises carbon at least partially coated with the composite material.

In some examples, in which the electrochemical cell is an electrolysis cell, the composite material comprises at least one metal and at least one carbon material (M/C). In some examples, the composite material comprises Ni.

In some examples, in which the electrochemical cell is an electrolysis cell, the counter electrode is configured to perform a hydrogen evolution reaction (HER).

In some examples, the cell is configured to hold an aqueous solution. In some examples, the cell is configured for holding aqueous solution having a pH of above 7. In some examples, the cell is configured for holding aqueous solution comprising hydrogen peroxide or a peroxide anion.

As shown in the examples below (FIGS. 28A-28C), the POR was demonstrated to take place concurrently with the hydrogen production via electrolysis of water (i.e., the hydrogen evolution reaction, HER). The reported operation works at significantly lower potential than the one practically required for water-splitting electrolysis where water is oxidized into oxygen in parallel to water reduction into hydrogen (in our case 0.9 V compared to the common bias of more than 1.5 V for water-splitting). An operational H₂ production cell was demonstrated in an H-cell for 16 h with FE=99.9%. The electrocatalyst mounts to a thermodynamic electricity power consumption for H₂ production via H₂O₂ electrolysis of only

$$21.47 kWh {kg}_{{H}_{2}}^{- 1} ,$$

which is 65.0% that of water
electrolysis

$$( 32.96 kWh {kg}_{{H}_{2}}^{- 1} ) ,$$

rendering this approach suitable for remote areas with constrained power supply.

In some embodiments which may be considered as aspects of the present disclosure, the electrochemical cell is for use as a sensor for hydrogen peroxide.

A hydrogen peroxide sensor as used herein refers to a device o designed to detect and quantify the presence of hydrogen peroxide (H₂O₂) in a given sample.

In some examples in which the electrochemical cell is a sensor for hydrogen peroxide, the composite material is for electrocatalysis in POR. In some examples in which the electrochemical cell is sensor for hydrogen peroxide, the composite material exhibits activity for the oxidation of H₂O₂ or HO₂⁻ to oxygen to during the POR if hydrogen peroxide is present in a sample. In some examples, the composite material is capable of adsorbing hydrogen peroxide, if present, on its surface and oxidize it during POR.

In some examples in which the electrochemical cell is a sensor for hydrogen peroxide, the working electrode may act as an anode. In some examples, the working electrode is or comprises carbon at least partially coated with the composite material.

In some examples, in which the electrochemical cell is a sensor for hydrogen peroxide, the composite material is represented by M/C. In some examples, the composite material comprises Ni.

The hydrogen peroxide sensor may be applicable to detect hydrogen peroxide in biological samples, food samples, and pharmaceutical samples.

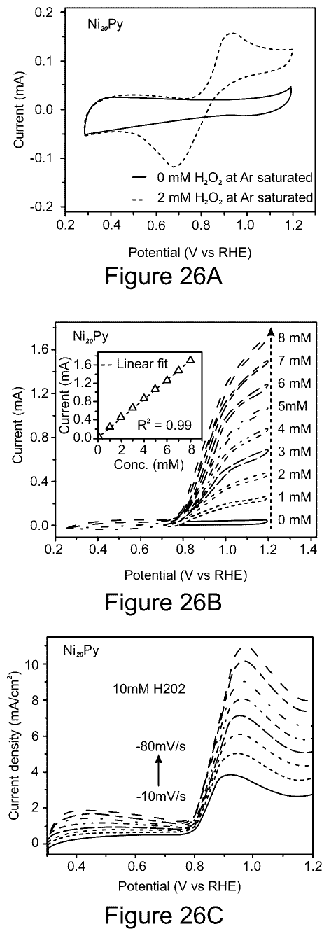

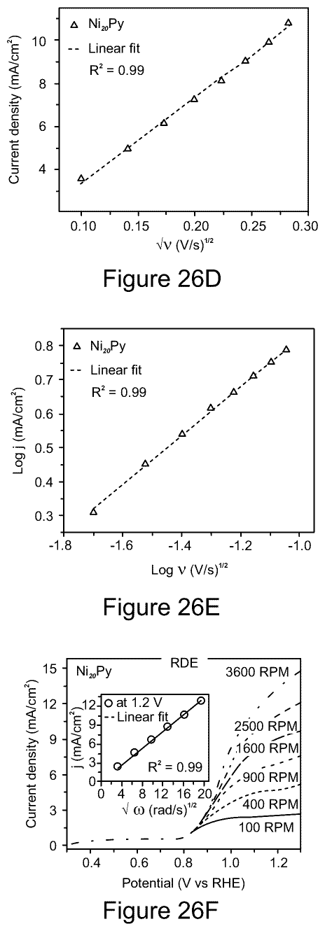

As shown in the examples below, for example in FIG. 26D, a plot using the Randles-Sevcik equation exhibits a linear slope, demonstrating the excellent adsorption of hydrogen peroxide to the electrode's surface and its oxidation, rendering the process diffusion-limited.

In some examples the electrochemical cell may be a non-partitioned cell.

In some examples the electrochemical cell may be a partitioned cell. In some examples, the cell may be partitioned with a membrane. In some examples, the cell may be partitioned with an anion exchange membrane (AEM).

In some embodiments which may be considered as aspects of the present disclosure, the electrochemical cell is used as a battery device.

A battery device as used herein refers to an electrochemical device consisting of one or more electrochemical cells, that converts chemical energy contained within its active materials directly into electric energy by means of an electrochemical oxidation-reduction (redox) reaction, in which electrons are transferred from one material to another via an electric circuit. In a collection of two or more of electrochemical cells, the cells may be connected in series, parallel, or both, depending on the desired output voltage and capacity. Connecting the cathode of one cell to the anode of the next cell is connecting in series. The voltages of all cells are added together. Connecting the cathode of one cell to the cathode of the other, and the anode to the anode is connecting them in parallel. The voltage stays the same, but the currents are added together. In principle, any galvanic cell could be used as a battery. Batteries are broadly classified into two categories: primary batteries can only be used once, and when the material in the cathode or anode is consumed or no longer able to be used in the reaction, the battery is unable to produce electricity. When these batteries are completely discharged, they become useless and must be discarded. Secondary batteries, also referred to as “rechargeable batteries”, can be charged and reused for many charging-discharging cycles. The electrochemical reactions that take place inside these batteries are usually reversible in nature. When discharging, the reactants combine to form products, resulting in the flow of electricity. When charging, the flow of electrons into the battery facilitates the reverse reaction, in which the products react to form the reactants.

In some examples, the battery is a rechargeable battery.

In some examples, the battery is a metal-air battery.

In some examples, the battery is a metal-peroxide battery where oxygen is selectively reduced to HO₂⁻ (peroxide) and HO₂⁻ and/or HO₂⁻ (peroxide) and HO₂⁻ is oxidized to oxygen.

Hence, in accordance with some aspects, the present disclosure provides a rechargeable metal-peroxide battery.

Rechargeable metal-air batteries utilize oxygen from the air as one of the reactants and is typically constructed from two electrodes, such that during discharge, one half cell, the anode, constitutes the following oxidation reaction: M→Mⁿ⁺+ne⁻, while the other half cell, the cathode, constitutes the following reduction reaction: O₂+2H₂O+4e⁻→4OH⁻ and during charge, the metal cations are reduced to their metallic state (metal electrode), while in the other half-cell oxygen is generated via oxygen evolution reaction (OER) as follows: 4OH⁻→2H₂O+O₂+4e⁻. In this overall reaction, 4 electrons are involved in the reduction of oxygen and in the transfer of charge.

The rechargeable metal-peroxide battery described herein provides a unique configuration as it comprises a working electrode that may exhibit reversible activity for the reduction and for the oxidation of oxygen via generation and oxidation of peroxide.

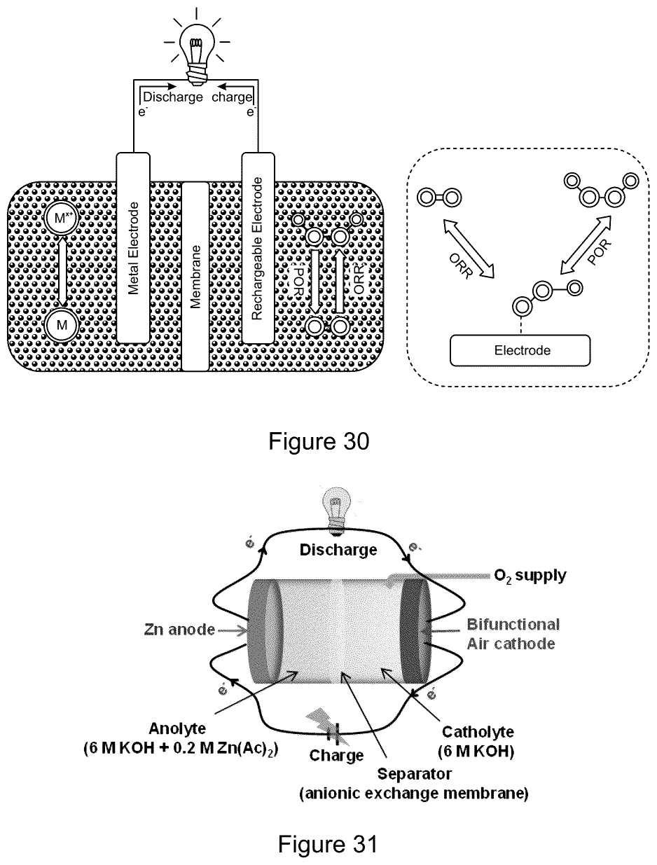

A schematic representation of an exemplary rechargeable metal-peroxide battery is shown in FIG. 30.

In some examples, the metal-peroxide battery constitutes during discharge reduction of oxygen to H₂O₂ or HO₂⁻ during ORR and during charge oxidation of H₂O₂ or HO₂⁻ to oxygen during POR.

In some examples, the reduction of oxygen to H₂O₂ or HO₂⁻ involves a two-electron transfer.

Without being bound by theory, it was suggested that despite of the fact that the metal-peroxide rechargeable battery involves two electrons transfer that is lower than the four electrons transfer in a standard metal-air battery, the metal-peroxide rechargeable battery is more efficient.

For example, the metal-peroxide rechargeable battery is characterized by an enhanced energy density. As appreciated, rechargeable battery need to store a significant amount of energy per unit volume or weight and hence higher energy density allows for longer-lasting and more powerful batteries, which is crucial for various applications.

In addition and as shown here, the metal-peroxide rechargeable battery is characterized by stable voltage over the discharge cycle.

In some examples, the rechargeable battery is configured to operate such that during discharge the working electrode serves as a cathode and the counter electrode serves as an anode.

In some examples, the counter electrode is or comprises zinc (Zn), iron (Fe), aluminum (Al) tin (Sn), calcium (Ca) or a combination thereof. In some examples, the counter electrode is or comprises zinc (Zn).

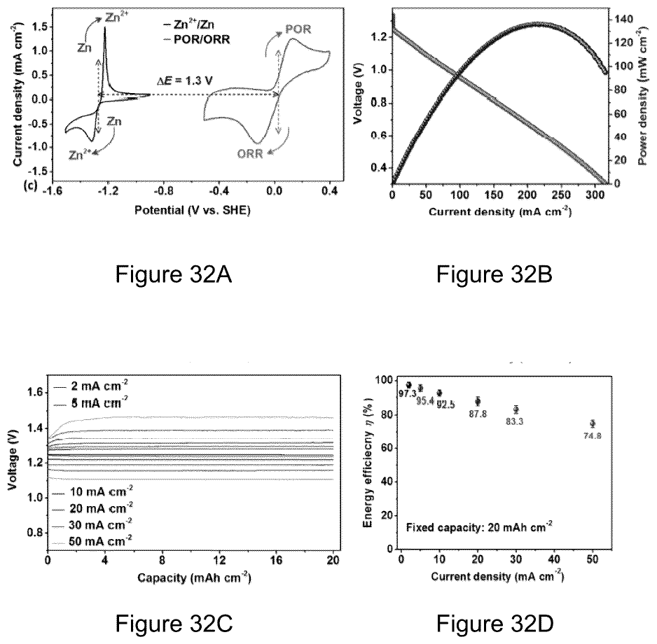

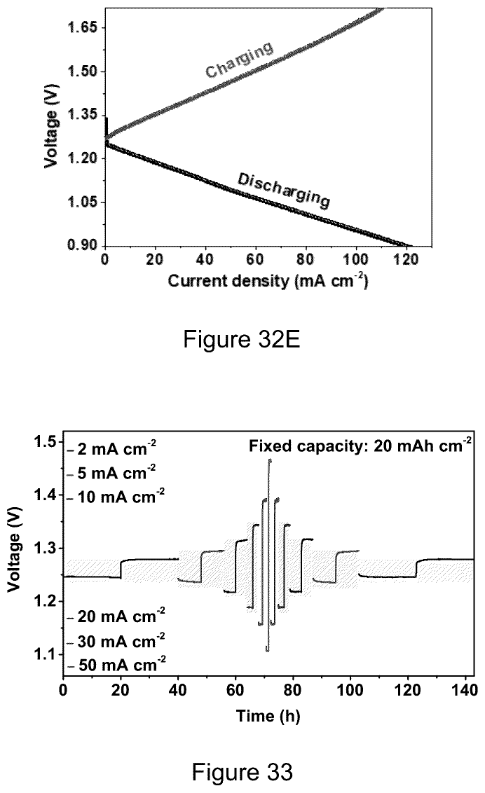

Further and as shown herein, for example in FIG. 32D, the metal-peroxide rechargeable battery is characterized by high round-trip efficiency (q), that is the ratio between to power invested during charging to the output power during discharge. This conversion of stored chemical energy into electrical energy during discharge relative to the invested energy to convert electrical energy into chemical energy during charging is crucial.

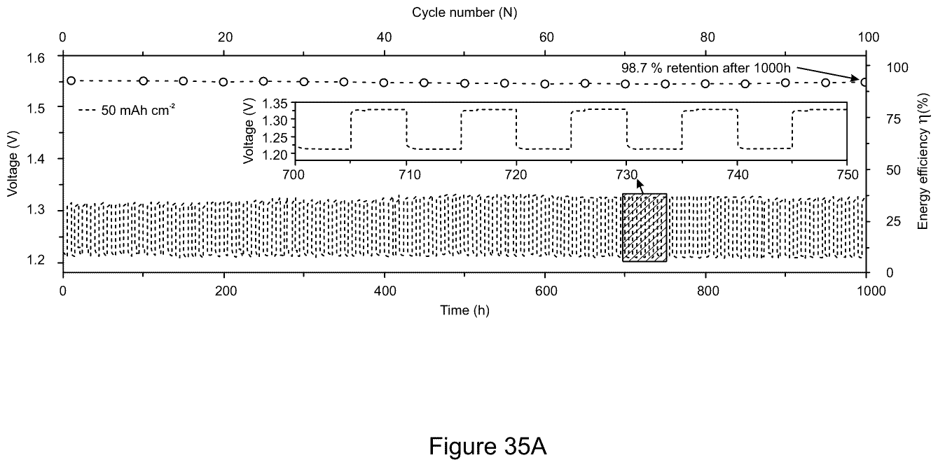

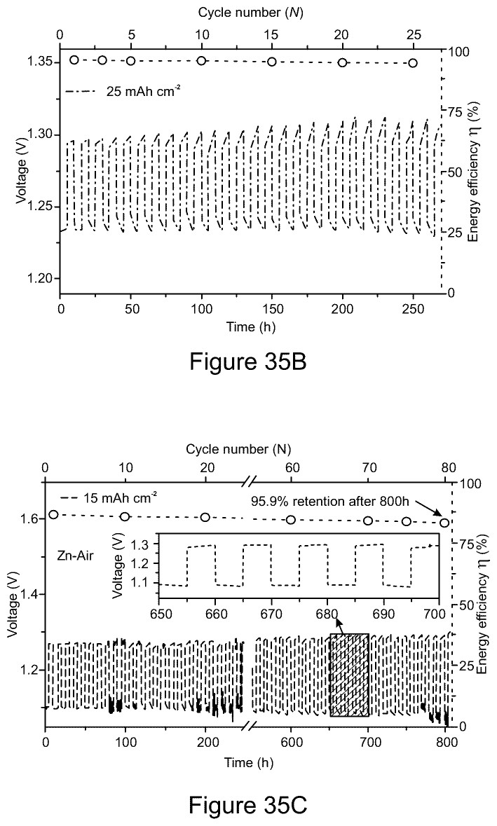

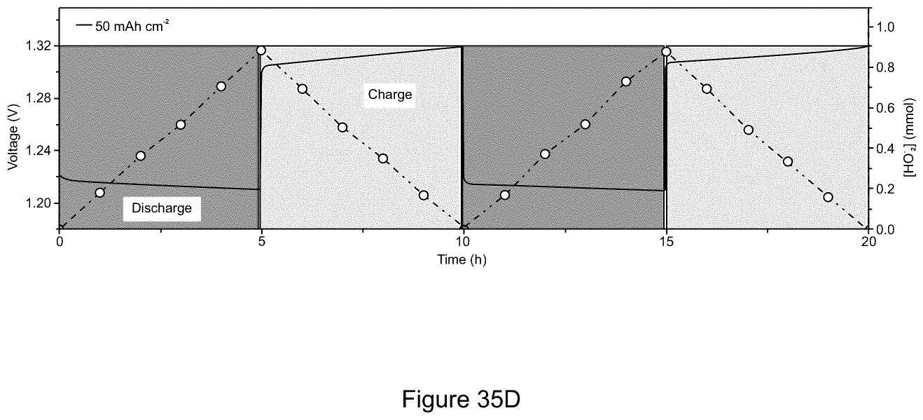

As shown in the examples below, for example in FIGS. 32A-32B, a rechargeable metal-peroxide (M₂-POR) battery was demonstrated for an unoptimized metal electrode (M₂=Zn foil), exploiting the excellent bifunctionality of peroxide redox chemistry as the rechargeable electrode. A maximum power density of 135 mW cm⁻² at 210 mA cm⁻² is demonstrated, similar to commercial Pt/C cathodes, thus eliminating the need in precious metal components or whole electrodes. The outstanding energy efficiency of 75% is achieved at 50 mA cm⁻² and 250 mAh cm¹, almost 3-fold higher than a state-of-the-art Zn-air battery (where the Zn anode was optimized). At lower currents (1-20 mA cm⁻²) and capacity values (10-100 mAh cm⁻²)>95% energy efficiency was achieved. A closed battery and long-term stability test, as shown in FIGS. 35A-35B, were demonstrated at 25 mAh cm⁻² and 50 mAh cm⁻² for 25 (275 h) and 100 (1000 h) cycles, respectively.

The present disclosure provides in accordance with some other aspects, a composite material represented by a formula M-C-X, wherein M is at least one metal source, C is at least one carbon source, and X is a heteroatom.

In accordance with some aspects, the composite material comprising at least one metal material (M), at least one carbon material (C) and at least one heteroatom (X).

In some examples, the composite material is represented by a formula MX/C. In some other examples, the composite material is represented by a formula M/CX.

In some examples, the composite material is for electrocatalysis in a nitrate reduction reaction (NO₃RR).

Nitrate reduction reaction (NO₃RR) as used herein refers to an electrochemical reaction that achieves nitrate (NO₃⁻(aq)) removal and ammonia generation simultaneously.

In some examples, the NO₃RR generates ammonia.

In accordance with some other aspects, the present disclosure provides use of a composite material represented by a formula M/C, wherein M is at least one metal material and C is at least one carbon material in electrocatalysis of ORR and/or POR.

In accordance with some other aspects, the present disclosure provides use of a composite material represented by a formula M/C, wherein M is at least one metal material and C is at least one carbon material in electrocatalysis of ORR and/or POR.

In accordance with some other aspects, the present disclosure provides use of a composite material represented by a formula MX/C, wherein M is at least one metal material, C is at least one carbon material, and X is at least one heteroatom in electrocatalysis of chemical reactions.

In accordance with some other aspects, the present disclosure provides use of a composite material represented by a formula M/CX, wherein M is at least one metal material, C is at least one carbon material, and X is at least one heteroatom in electrocatalysis of chemical reactions.

In accordance with some other aspects, the present disclosure provides use of a composite material represented by a formula MX/C, wherein M is at least one metal material, C is at least one carbon material, and X is at least one heteroatom in electrocatalysis of ORR and/or POR.

In accordance with some other aspects, the present disclosure provides use of a composite material represented by a formula M/CX, wherein M is at least one metal material, C is at least one carbon material, and X is at least one heteroatom in electrocatalysis of ORR and/or POR.

In accordance with some other aspects, the present disclosure provides use of a composite material represented by a formula MX/C, wherein M is at least one metal material, C is at least one carbon material, and X is at least one heteroatom in electrocatalysis of NO₃RR.

In accordance with some other aspects, the present disclosure provides use of a composite material represented by a formula M/CX, wherein M is at least one metal material, C is at least one carbon material, and X is at least one heteroatom in electrocatalysis of NO₃RR.

In accordance with some other aspects, the present disclosure provides a method for electrocatalysis of ORR or POR, the method comprising contacting a composite material represented by a formula M/C, wherein M is at least one metal material and C is at least one carbon material with an oxygen source and/or a solution comprising hydrogen peroxide (H₂O₂) or a peroxide anion (HO₂⁻) allowing said ORR or POR.

In accordance with some other aspects, the present disclosure provides a method for electrocatalysis of ORR and POR, the method comprising contacting a composite material represented by a formula M/C, wherein M is at least one metal material and C is at least one carbon material with an oxygen source and/or a solution comprising hydrogen peroxide (H₂O₂) or a peroxide anion (HO₂⁻) allowing said ORR and POR.

In accordance with some other aspects, the present disclosure provides a method for electrocatalysis of NO₃RR, the method comprising contacting a composite material represented by a M-C—X, wherein M is at least one metal material, C is at least one carbon material, and X is a non-metal heteroatom containing material with an oxygen source and/or a solution comprising nitrate allowing said NO₃RR.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. In some embodiments, the term “about” refers to ±10%.

As used herein, the forms “a”, “an” and “the” include singular as well as plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

It should be noted that the various embodiments and examples detailed herein in connection with various aspects of the invention may be applicable to one or more aspects disclosed herein. It should be further noted that any embodiment described herein may be applied separately or in various combinations. Various embodiments and aspects of the present invention as delineated hereinabove and as claimed in the claims section below find experimental support in the following examples. The phrases “in another embodiment” or any refence made to embodiment as used herein do not necessarily refer to different embodiment, although it may. Thus, various embodiments of the invention can be combined (from the same or from different aspects) without departing from the scope of the invention.

Various embodiments and aspects of the present invention as delineated herein above and as claimed in the claims section below find experimental support in the following examples.

Disclosed and described, it is to be understood that this invention is not limited to the particular examples, composite materials, cell, systems, battery, disclosed herein as such composite materials, cell, systems, battery, may vary somewhat. It is also to be understood that the terminology used herein is used for the purpose of describing particular embodiments only and not intended to be limiting since the scope of the present invention will be limited only by the appended claims and equivalents thereof.

The following examples are representative of techniques employed by the inventors in carrying out aspects of the present invention. It should be appreciated that while these techniques are exemplary of preferred embodiments for the practice of the invention, those of skill in the art, in light of the present disclosure, will recognize that numerous modifications can be made without departing from the spirit and intended scope of the invention.

### SOME NON-LIMITING EXAMPLES

The following chemicals were obtained from the indicated supplier and used without any further purification: pyrene (Py, 98%, Acros Organics, 145-148° C. melting point), nitric acid (HNO₃, 67-69 wt. %, trace metal grade, Fisher Chemical), nickel (II) nitrate hexahydrate (Ni(NO₃)₂·6H₂O, >99%, Sigma-Aldrich), isopropyl alcohol (IPA, LOBA Chemie, India), ethanol (EtOH, AR grade, Macron Fine Chemicals), sulfuric acid (H₂SO₄ (95-98%), AR grade, Carlo Erba), hydrochloric acid (HCl 37 wt. %, AR grade, LOBA Chemie, India), Nafion (5 wt. %, Sigma-Aldrich), hydrogen peroxide (H₂O₂, 30 wt. %, Sigma-Aldrich), and potassium hydroxide pellets (KOH, pellets 85 wt. %, AR grade, LOBA Chemie, India). Deionized water (18.2 MΩ cm resistivity at 25° C., Millipore Direct Q-3 purification system) was used for all reported results.

### 1. Characterization Details.

a. Powder X-ray diffraction (XRD). A Panalytical Empyrean powder diffractometer (position-sensitive detector X′Celerator, operation parameters: Cu Kα, =1.54178 Å, 40 kV, 30 mA) was used for powder XRD measurements. Powder XRD patterns were recorded over −19 min with 2θ ranging between 5° and 80°.
b. X-ray photoelectron spectroscopy (XPS). The surface chemical states of the samples were analyzed by XPS; the data was collected by using an ESCALAB 250 ultrahigh vacuum (1×10⁻⁹ bar) X-ray photoelectron spectrometer with an Al Ku X-ray source and a monochromator. The X-ray beam size was 500 μm. Survey spectra were recorded with a pass energy (PE) of 150 eV, and high-energy resolution spectra were recorded with a PE of 20 eV. Depth profiles were acquired by combining a sequence of Ar⁺ (Uₛₚ=3 kV) gun etch cycles interleaved with XPS measurements from the current surface. Successive sputtering was applied with a rate of 0.07 mm s⁻¹ for a total of approximately 90 s. To correct for charging effects, all binding energies were calibrated to the C is peak of adventitious carbon at 284.6 eV. The XPS results were processed using the Avantage software from Thermo Fisher Scientific.
c. High-resolution scanning electron microscopy (HRSEM). Surface morphology was probed by HRSEM using a Thermo Scientific Verios XHR 460L operated at U₀=5.0 kV, a probe current of 25 pA, and a through-the-lens detector (TLD). Energy-dispersive X-ray spectroscopy (EDS) elemental mappings were obtained using an Oxford Instruments EDS detector coupled to the Verios 460L SEM, at U₀=20.0 kV, mapping the K-edges of the elements.
d. High-resolution transmission electron microscopy (HRTEM). A JEOL JEM-2100F analytical TEM operated at 200 kV was used for HRTEM imaging and energy-filtered TEM (EFTEM). The EFTEM experiments were performed using a GATAN 894 US1000 camera and a Gatan image filter at the following energies: C K-edge (284 eV) and Ni L-edge (855 eV).
e. Raman spectroscopy. Raman spectroscopic measurements were done in a Horiba LabRam HR evolution micro-Raman system equipped with a Synapse Open Electrode CCD detector air-cooled to −60° C. Raman spectra were recorded using the 532 nm laser with a typical exposure time of 120-180 s.
f. In situ attenuated total reflectance Fourier-transform infrared (ATR-FTIR) spectroscopy. Spectroelectrochemical measurements were recorded using a Thermo Nicolet iS50 instrument equipped with a Harrick Praying Mantis diffuse reflectance infrared Fourier transform spectroscopy (DRIFTS) apparatus using a liquid-nitrogen-cooled MCT-A detector with a CdSe window in the spectral range of 11,700-600 cm⁻¹. A Beijing Scistar Technology spectro-electrochemical cell was mounted on a PIKE Technologies VeeMAX III ATR optic accessory using a flat ZnSe window. UIO-66 gel was then drop cast on a carbon working electrode designed to fit the electrochemical FTIR cell and serve as the working electrode.
g. Electrochemical measurements. For all measurements, a thermostat regulated the temperature to 25° C. A standard three-electrode (working, counter, and reference) electrochemical cell with 50 mL 0.5 M aqueous KOH (pH 13.89) as the electrolyte and a potentiostat (Ivium Instruments, Netherlands) was used. For RRDE measurements, the same setup was coupled to an RRDE-3A ver. 3.0 (ALS Co. Ltd., Japan). NiₓPy-modified glassy carbon (GC, diameter 3 mm) was used as the working electrode, Pt foil (1×1 cm²) as the counter electrode, and Hg/HgO/OH⁻ as the reference electrode. Before each measurement, electrochemical cycling was carried out in the respective electrolyte to electrochemically clean the surface. For oxygen reduction reactions (ORR), the electrochemical investigations were performed in an oxygen-saturated 0.5 M KOH aqueous electrolyte and the surface of the solution was maintained under an O₂ blanket. The uncompensated resistance (Rᵤ) was obtained by impedance spectroscopy at a frequency of 100 MHz, and a peak-to-peak amplitude of 10 mV. EIS was recorded in the frequency range of 100 kHz to 10 mHz with an AC amplitude of 10 mV (peak to peak) and at a bias voltage of 1.20 V vs. RHE.

The NiₓPy-modified GC electrodes were prepared by the drop-casting method: The GC electrode was cleaned by polishing with 0.05 μm alumina powder. A homogeneous dispersion was prepared by sonicating a known amount of catalyst (denoted as NiₓPy in accordance with the used reactants) in isopropyl alcohol (IPA) with 5 wt. % Nafion as the binder to prepare the composite ink, which was drop-cast on the surface of the GC electrode.

The current was divided by the geometrical surface area of the working electrode to calculate the current density (j). Errors were determined from the standard deviation over four measurements.

All the potentials were converted to the standard hydrogen electrode (SHE) scale:

$${E}_{SHE} = {E}_{Ag / AgCl / {Cl}^{-}} + 0.197 V \qquad ( Eq . 1 )$$

or to a reversible hydrogen electrode (RHE) scale using the Nernst equation at room temperature:

$${E}_{RHE} = {E}_{Ag / AgC1 / {Cl}^{-}} + 0.059 \times pH + 0.197 V \qquad ( Eq . 2 )$$

### Density Functional Theory (DFT) Methodology.

DFT calculations were carried out for periodically repeated supercells using the Quantum-Espresso to compute the interactions between O₂, H₂O, and H₂O₂ and the NiO (001) surface. The ion-core electrons of the computed atoms were described by ultrasoft pseudopotentials generated with a scalar relativistic correction. Only the 2s and 2p electrons of oxygen, the is electron of hydrogen, and the 3d, 4s, and 4p electrons of nickel were treated explicitly. For the plane-wave expansion, we used: a k-mesh of 2×2×1 to sample the Brillouin zone according to the scheme of Monkhorst and Pack¹, a kinetic cutoff of 50 Ry for the wave function, and 330 Ry for the charge density. The exchange-correlation potential was treated using the Perdew-Burke-Ernzerhof (PBE) generalized gradient approximation (GGA)². For structure relaxation, a self-consistent convergence criterion of 10⁻⁵ Ry was imposed for each cycle, where complete relaxation of the atoms was carried out until the change in energy was less than 10⁻⁴ Ry and the residual forces of the atoms were less than 10⁻⁴ Ry/B³.

### Example 1: Preparation of Micro/Mesoporous Heteroatom-Doped/Incorporated Carbon Materials Using a Template

Micro/mesoporous heteroatom-doped/incorporated carbon materials can be acquired by forming a mixture of several precursors (polycyclic aromatic hydrocarbons (PAHs) and possible additives) and templating agents such as SiO₂, anodic aluminum oxide (AAO), salt melt mixtures (LiX, NaX, KX, RbX, MgX₂, CaX₂, ZnX₂, etc., where X=Cl, Br, I).

### Materials and Methods

N-doped mesoporous carbon materials (NdC) were synthesized as follows: SiO₂ spherical nanoparticles (SBA-15, <150 μm) of various pore sizes (4-8 nm) were mixed with 1,10-phenanthroline (PheN, m.p.~115° C.) in different mass ratios (SiO₂/PheN) in a ceramic crucible. The crucible was transferred to a muffle furnace operated under an inert environment. First, the crucible was purged with N₂ and heated to 90° C. for 1 h. Next, using a heating ramp of 2.5° C. min⁻¹ for 1 h, the crucible was heated to 150° C. and was allowed to dwell at this temperature for 1 h. Subsequently, the reaction mixture was heated to 800° C. at a heating rate of 2.5° C. min⁻¹ and dwelled at this temperature for 4 h. Lastly, the crucible was allowed to cool down to room temperature under an inert environment. In order to remove the silica, the resulting powders were washed with a 6 M NaOH solution at 70° C. for 24 h. After the NaOH treatment, the powders were filtered and washed with distilled water (purified to a resistivity of 18 MΩ cm) until the solution reached pH 7. The powders were dried in a vacuum oven at 60° C. for 24 h resulting in very fine NdC black powders.

### Results

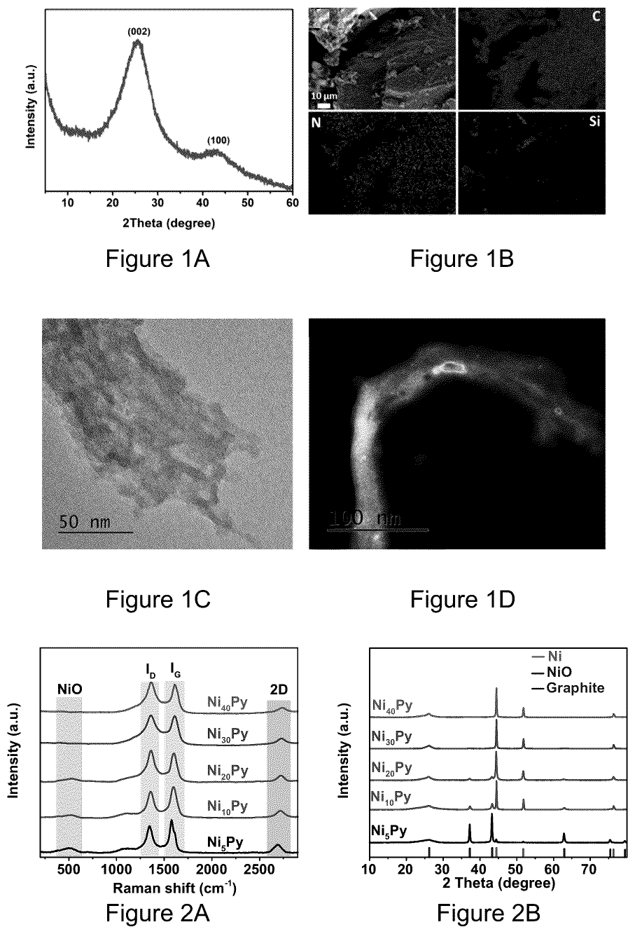

The XRD pattern (FIG. 1A) of NdC shows typical diffraction signals of graphitic-like carbon at 2θ=25.6° and 43.25°, corresponding to sheets stacking (002) and the in-plane repeating unit (100). The d-spacing at the (002) peak is 3.47 Å, which is larger than that of pristine graphite (3.35 Å), suggesting three possible structural features of SiO₂/PheN: (1) nano-carbons with varying orientations, (2) insertion of a larger atom as N into the carbon network, therefore increasing the interplanar distance between the graphitic sheets, and (3) the successful N insertion introduces deformations to the graphitic structure, resulting in more amorphous carbon. The SEM image (FIG. 1B) shows no special morphological features but rather a bulky material. The corresponding energy-dispersive X-ray spectroscopy (EDS) mapping (FIG. 1B) reveals a homogenous distribution of C and N throughout the particle with a small amount of Si, probably due to insufficient NaOH washing. High-resolution transmission electron microscopy (HRTEM) and high-angle annular dark-field scanning transmission electron microscopy (HAADF-STEM) (FIG. 1C and FIG. 1D, respectively) demonstrate that the result of SiO₂/PheN synthesis is a porous NdC material with a wire-like morphology.

### Example 2: Bifunctional Catalyst(s) Preparations and Characterization

### Materials and methods

The metal-incorporated carbon composite electrocatalyst (M/C) was synthesized via the developed molten-state synthesis as follows: molten carbon precursors, polycyclic aromatic hydrocarbons (PAHs) or their derivatives with a possible small molecules addition, and any metal salt (anhydrous or hydrated) were mixed and transferred into a ceramic crucible that underwent several stages of pyrolysis in a furnace under an inert gas atmosphere. First, the mixture was heated for a certain amount of time (e.g., 1 h) at low temperatures (<100° C.) to evaporate off any impurities adsorbed to the surface of the precursors, followed by a heating stage at a defined rate (e.g., 2.5° C. min⁻¹) above the precursors' melting points and maintaining this for a certain amount of time (e.g., 1 h), releasing trapped water molecules and forming a molten-state intermediate, enabling a homogeneous distribution of elements. Then the mixture was then heated at a defined rate (e.g., 2.5° C. min⁻¹) to reach the final custom reaction temperature (>500° C.) according to the exact reactants' composition and desired product and allowed to stay there for several hours (>2 h); after the reaction time it was cooled to room temperature, either under air or under a protective inert atmosphere. The final electrocatalyst was named MₓPAH, to represent the reactants, where M, x, and PAH, stand for the incorporated metal (Mn, Fe, Co, Ni, Cu, Zn, Mo, W, V, Cr, W, Y, Zr, Eu, Ce and other transition metals, as well as Sn, Sb, Al, Bi, Mg, Ca, Na, K, Rb, Sr, Cs, Ba), the weight ratio between the metal in the metal salt reactant and the total reactants mixture mass (i.e., wt. %), and the identity of the PAH used (naphthalene, anthracene, phenanthrene, fluorene, tetracene, triphenylene, pyrene, pentacene, perylene, fluoranthene, and any PAH or its derivative that has a stable molten-state), respectively.

Using the same method, single, binary, or ternary metal-incorporated carbon materials can be synthesized with up to 70 wt. % of metals where any ratio of metals can be synthesized (instead of just one M, a binary M₁₍ₓ₎M₂₍₁₋ₓ₎ or a ternary M₁₍ₓ₎M_{2(y)}M_{3(1-x-y)}). When relevant, heteroatom (e.g., N, S, B, O, F, Cl, Br, I, and P) can be incorporated by adding a reactant or varying the PAH's identity in the reactant mixture before reaching the molten state. Trace amounts of heteroatoms can be incorporated in the final material as a result of addition of a salt (the metal source and/or another). For example, adding triphenylphospine (PPh₃) to M=Ni and PAH=pyrene, results in a composite containing both Ni and Ni₃P nanoparticles, embedded in a carbon composite with controlled composition.

The metal/carbon (M/C) composite electrocatalyst was synthesized via a molten-state synthesis¹: pyrene (Py) and Ni(NO₃)₂·6H₂O were mixed and then transferred into a ceramic crucible that underwent several stages of pyrolysis in a furnace under an inert gas atmosphere. First, the mixture was heated for 1 h at a low temperature (<100° C.) to evaporate off any impurities adsorbed on the surface of the precursors. It was then heated above the melting points of the precursors for 1 h, the mixture forming a molten-state intermediate, enabling a homogeneous distribution of elements. Then, the mixture was heated at a rate of 2.5° C. min⁻¹ to reach the final reaction temperature (>500° C.), which was maintained for several hours (>2 h); after this, the mixture was let to cool down to room temperature. It was transferred to a 500 mL beaker containing deionized water. The resulting suspension was stirred for 24 h to wash any unreacted metallic salts in the reaction mixture. After filtering the solid from water, it was washed in the same manner with EtOH to remove any unreacted Py, and the filtration step was repeated. The gathered solid was dried in a vacuum oven for 24 h. The final product is named as NiₓPy, where x is the weight percent of nickel in the precursor. Samples with 5, 10, 20, 30, and 40 wt. % Ni were prepared, namely Ni₅Py, Ni₁₀Py, Ni₂₀Py, Ni₃₀Py, and Ni₄₀Py, respectively.

### Results

Hereon forth, the material characterizations will mainly address a Ni/C composite: nickel (Ni) metal-based electrocatalysts were synthesized by pyrolyzing a nickel-containing precursor (nickel nitrate hexahydrate) in the presence of a molten-state carbon source at 750° C. under an inert atmosphere.

The Ni content was altered by altering the weight ratio of nickel precursor to pyrene (Py) in the precursor. The final materials consist of Ni embedded into crystalline carbon, (i.e., Ni/C) referred to here as NiₓPy, where x represents the weight percentage of Ni in the precursor.

Raman analysis (FIG. 2A) shows that two carbon-related peaks exist: a D peak denoting the level of defects within an sp²-hybridized carbon system and a G peak describing the level of graphitization. Moreover, the Raman result shows that the amount of NiO relative to Ni decreases with increasing Ni precursor wt. %, until it is not detected at 30% wt., in the Ni₃₀Py sample. X-ray diffraction (XRD) patterns (FIG. 2B) of NiₓPy show the formation of nickel, nickel oxide (NiO), and graphite. When a low amount of Ni cations was mixed with Py, more pronounced peaks of NiO were pronounced and less for Ni; however, when a more considerable amount of Ni cations was used, the trend was the opposite until no NiO peaks were visible at x≥30 wt. %. As such, several phases of metals can be incorporated into the carbon material. In addition, all the materials show peaks attributed to graphite to some extent, demonstrating the formation of crystalline carbon during the synthesis. The XRD analysis affirms the measured trends using Raman spectroscopy.

The molten-state synthesis can be used to achieve metal-based nanoparticles (NPs) within a carbonaceous matrix. High-resolution scanning microscope (HRSEM) images (FIG. 3A) show how M=Ni NPs (bright spots) are dispersed uniformly on a carbon material as the molten-state synthesis entails a molten-state intermediate, where the metal cations can be evenly distributed.

During the molten-state synthesis, metallic-based NPs of varying sizes (1-50 nm) are formed and coated with a graphitic layer, as seen in the high-resolution transmission electron microscope (HRTEM) images (FIG. 3B). Energy-filtered TEM images (EFTEM, FIGS. 3B-3F) confirm the formation of metallic nanoparticles (either metal or metal-oxide phase) in a carbonaceous environment.

The HRSEM imaging (secondary-electron detector, FIGS. 3G-3K) shows how metal nanoparticles (bright spots) are dispersed uniformly on the carbon material. This uniformity was ascribed to the molten-state synthesis, since heating a polycyclic aromatic hydrocarbon such as pyrene above its melting point results in a molten-state intermediate, in which metal cations are evenly distributed. FIGS. 3G-3K present HRSEM images and FIGS. 3L-3P the corresponding elemental compositions (via EDS measurements) of different NiₓPy compositions.

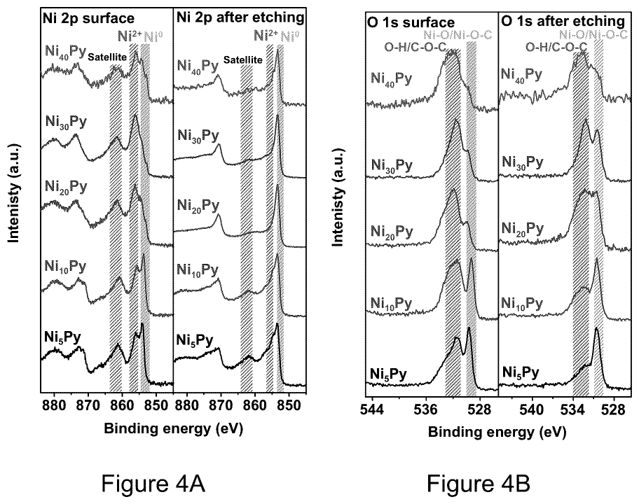

The chemical environments of Ni and O elements in NiₓPy (M/C composite, prepared from an M salt and PAH carbon source, where M=Ni; PAH=Py (pyrene), and x is M's wt. % in the reactants) were examined using X-ray photoelectron spectroscopy (XPS) in two spots; one spot on the surface and the other after 90 s of Ar etching (0.07 nm s⁻¹), which corresponds to the composition within the material (“bulk”, FIG. 4). The Ni 2p_{3/2} spectra of the surface reveal two chemical states at ~853.0 eV and ~856.0 eV, which fit metallic Ni and NiO, respectively. The O is spectra confirm the existence of Ni—O/Ni—O—C at 529.0 eV and physically adsorbed O—H/C—O—C at 532.5 eV. The spectra of Ni 2p and O is in the “bulk” exhibit a significant decrease in NiO species and an increase in metallic Ni moieties showing that the NiO forms mainly on the surface; we ascribe it to surface oxidation or surface coordination of Ni²⁺ and adsorbed O—H.

### Example 3: Characterization of Oxygen Reduction Reaction (ORR) and Hydrogen Peroxide (H₂O₂) Oxidation Reaction (POR)

The synthesized M₁/C composite materials can be used as catalysts for the ORR towards the selective production of H₂O₂ (2e⁻ process) or complete reduction to H₂O (a 4e⁻ process).

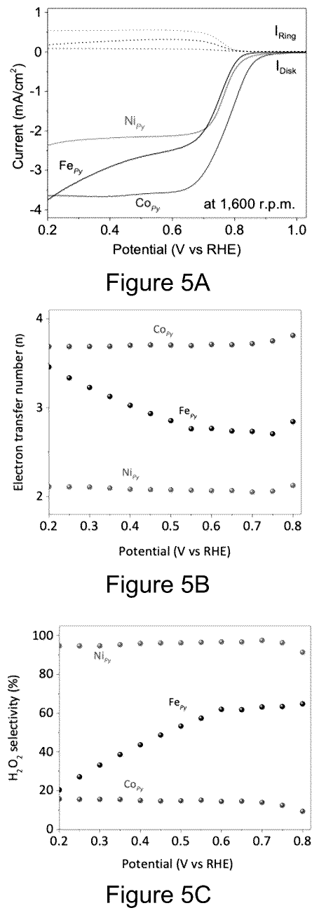

ORR was examined using a rotating ring-disk electrode (RRDE) in an O₂-saturated 1 M KOH with a rotation speed of 1600 rpm, where the glassy carbon disk was coated with a M₁/C catalyst, while the ring was composed of Pt. Three monometallic M₁/C catalysts are presented, with M=Ni, Fe, and Co (each at 20 wt. %) and electrochemically characterized in FIGS. 5A-5C.

To examine in depth the electrocatalytic activity of the most selective electrocatalyst (M/C, M=Ni), NiₓPy, for HO₂⁻ production (ORR), hydrodynamic voltammetry was carried out using RRDE, in which the disk electrode was glassy carbon coated with the NiₓPy electrocatalyst and the ring electrode was Pt.

RRDE experiments were performed using a glassy carbon (GC) disk electrode (area=0.125 cm²) and a platinum (Pt) ring (area=0.188 cm²) electrode. The electrode cleaning was carried out by soaking in dilute sulfuric acid and hydrogen peroxide solution. The electrode was then rinsed repeatedly in boiling water and electrochemically cleaned in 0.5 M H₂SO₄ aqueous solution in the potential range of 0.2 to 1.3 V vs. RHE. The disk electrode was then modified with NiₓPy catalyst by drop casting.

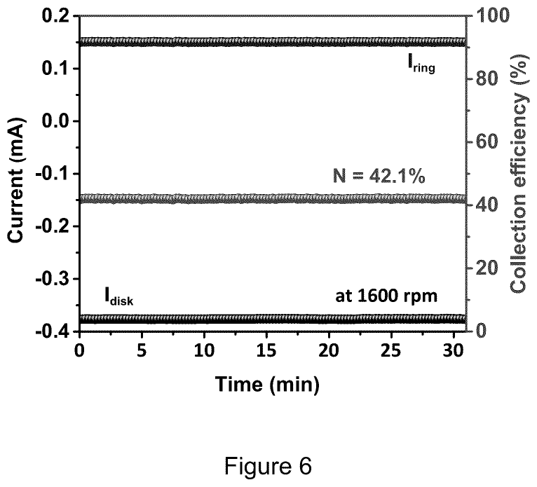

All the RRDE electrochemical measurements were collected in oxygen-saturated 0.5 M KOH aqueous solution in a three-electrode system containing a NiₓPy-modified glassy carbon electrode as the working electrode. The disk electrode was scanned cathodically between 0.2 and 1.1 V vs. RHE at a scan rate of 5 mV s⁻¹, keeping the ring potential constant at 1.0 V vs. RHE. The disk and ring currents were acquired at various rotation rates (100, 400, 900, 1600, 2500, and 3600 rpm). The % of HO₂⁻ and the electron transfer number (n) were determined using equations 3 and 4³⁻⁵.

$$\% {H}_{2} {O}_{2} = 200 [ ( \frac{{I}_{r}}{N} ) / ( {I}_{d} + ( \frac{{I}_{r}}{N} ) ) ] \qquad ( Eq . 3 )$$

$$n = 4 \frac{{I}_{d}}{{I}_{d} + ( \frac{{I}_{r}}{N} )} \qquad ( Eq . 4 )$$

where I_{d} is the disc current, Iᵣ is the ring current, and N is the collection efficiency of the Pt ring electrode (measured N is 0.420). The collection efficiency N was determined using a NiₓPy-modified glassy carbon electrode as the working electrode, Ag/AgCl (3 M KCl) as the reference electrode, and platinum as the counter electrode, in a N₂-saturated 5 mM potassium ferricyanide solution; chronoamperometry was performed at −0.3 V (vs. Ag/AgCl, 3 M KCl) and keeping the ring potential at 0.5 V (vs. Ag/AgCl) for ~30 min with a rotation rate of 1600 rpm (shown in FIG. 6).

The Ni-based electrocatalyst shows the highest performance, thus composition optimization (Ni-to-pyrene precursors ratio) was conducted (FIGS. 7A-7C). Linear sweep voltammetry (LSV) curves of Ni₂₀Py and ring show cathodic currents (i_{c}) of −0.1 mA cm⁻¹ at an onset potential of 0.84 V (vs. RHE), corresponding with the reversible 2e hydrogen peroxide production/oxidation pathway in pH=14 (FIG. 7A). The competing reaction to hydrogen peroxide (as its anion, HO₂, at this pH) production is oxygen reduction to hydroxyl groups (OH⁻) in a 4e process. The NiₓPy electrocatalysts show an electron transfer number close to two (FIG. 7B), attributed to hydrogen peroxide formation, with 97% selectivity (FIG. 7C).

Among the different NiₓPy electrocatalysts (FIG. 7A-C), Ni₂₀Py has the best selectivity (98%) and the lowest onset potential for HO₂⁻ generation at a potential range of 0.20 to 0.84 V vs. RHE (FIG. 7A), along with an electron transfer number closest to 2 (n in FIG. 7B).

These results show that Ni₂₀Py is an efficient non-noble metal electrocatalyst for the O₂ reduction to HO₂⁻ via hydroperoxyl (*HOO) as the intermediate, over a wide potential window, with a selectivity of 98% towards HO₂⁻ (FIG. 7C), which is among the highest reported values for a non-precious metal-based catalyst.

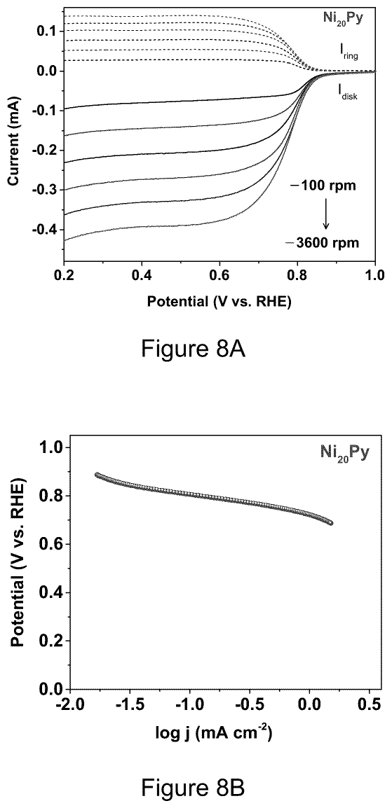

Notably, the high selectivity for the 2e⁻ reduction is maintained at different rotation rates (FIG. 8A); no further reduction of the HO₂⁻ to water is observed. The low Tafel slope of −70 mV per decade for Ni₂₀Py (FIG. 8B) further corroborates the conclusion that HO₂⁻ production occurs with rapid kinetics on Ni₂₀Py.

In RRDE stability measurements at a 0.6 V disk potential, Ni₂₀Py shows 97% selectivity towards the hydrogen peroxide pathway and excellent stability over 10 h (FIG. 9A). Its selectivity remains exceptional even after prolonged operation (100 h, FIG. 9B), and its stability is impressive as only a slight shift of the onset potential to 0.83 V occurs (ΔE=10 mV, FIG. 9C). The selectivity is maintained at different potentials after the Ni₂₀Py stability test (FIG. 9D).

Post-operation analysis (after 100 h of continuous testing) that includes Raman, XRD, and XPS measurements show no change in the structural features of the material (FIG. 10A-10C) confirming excellent stability of the catalyst. This conclusion stems from comparing the integrity of the measured peak positions and their intensity before and after operation the graphitic material composition (Raman, FIG. 10A), Ni and crystalline carbonaceous matrix (XRD, FIG. 10B), and chemical composition and environment of the Ni, O, and C (XPS, FIG. 10C).

HRSEM images show that the morphological properties also stay the same as can be seen from an image obtained prior to (FIG. 11A) and after 100 hours of continuous testing (FIG. 11B). These analyses accentuate the catalyst's stability after extensive use.

To elucidate the reaction mechanism and intermediates during operation, in situ attenuated total reflection infrared spectroscopy (ATR-FTIR) was used during ORR and POR.

In situ ORR studies (FIG. 12A-C) disclose no evident absorption bands related to hydroperoxyl species (OOH⁻) at potentials below the ORR onset (0.85 V vs. RHE). A new absorption band at ~1044 cm 1, correlated to the O—O stretching mode of adsorbed hydroperoxyl OOH* during ORR is detected at 0.8 V vs. RHE, that is, the onset of HO₂⁻ production.

This absorption band gradually increases at more negative potentials up to 0.4 V vs. RHE (FIG. 12A). The existence of OOH* as an intermediate confirms the associative 2e⁻ pathway during the ORR. The full coverage of the catalyst surface with Ni—OOH at a wide potential range is one of the reasons for the lack of further reduction of HO₂⁻ to water.

FIG. 12B shows a schematic representation of this mechanism. FIG. 12C shows the experimental setup where the FTIR spectrometer and the attenuated total reflection apparatus is coupled to an electrochemical 3-electrode configuration.

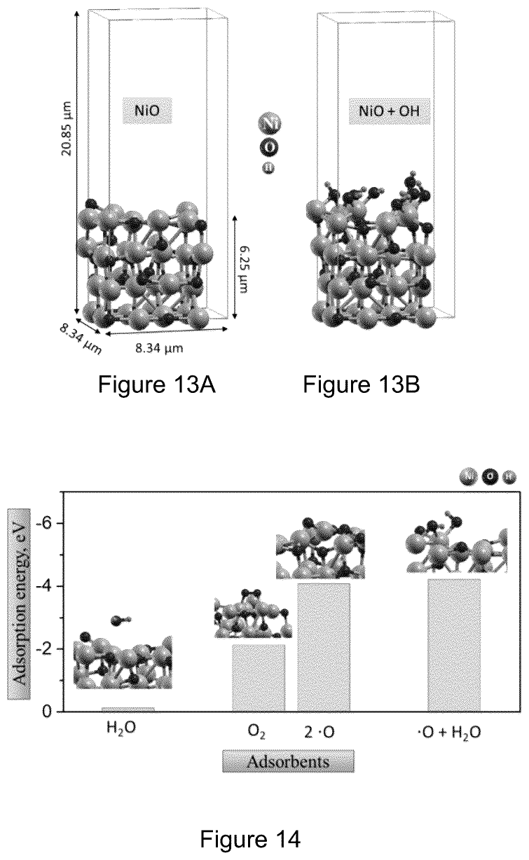

During density functional theory (DFT) calculations (FIGS. 13-15) with the following computational details were used to compute the surface of NiO and its affinity to hydroxyls using NiO model oriented in the (001) direction, which had been found⁶ as the most stable facet with the lowest surface energy (0.958 J m⁻²). The surface modeled with periodic boundary conditions of a supercell slab with a vacuum separation of 14.6 Å. The initial slabs were built based on a relaxed bulk unit cell. Further relaxation was allowed to define the optimum lattice parameter and enable the atoms in the slab to adjust their relaxed positions. For the present study, all the atoms were allowed to relax and only the atoms on the first bottom layer were kept fixed to their bulk positions. A new supercell was built to demonstrate a NiO+0.5 monolayer of hydroxyls located between Ni atoms of the NiO surface for further calculation. This location was in the NiOOH compound.

FIG. 13A and FIG. 13B describe the relaxed NiO supercell and the relaxed surface model of the NiO+hydroxyl, respectively. To define the preferred locations of some adsorbents (O₂, H₂O, and H₂O₂) over these surfaces and compute their interactions with the surfaces, several initial locations are considered for each molecule and allowed to relax with the corresponding supercell. The adsorption energies (E_{ads}) of selected isolated and dissociated molecules over NiO and NiO+OH substrates were computed according to Eq 5 for each final relaxed configuration.

$${E}_{a d s} = {E}_{rlx}^{s y s} - ( {E}_{rlx}^{slab} + {E}_{rlx}^{{H}_{2} O or {O}_{2}} ) \qquad ( Eq . 5 )$$

where

$${E}_{rlx}^{s y s}$$

is the total energy of the relaxed slab (NiO or NiO+OH) with the relaxed isolated or dissociated molecule (H₂O, O₂, or H₂O₂),

$${E}_{rlx}^{slab}$$

is the total energy of the corresponding relaxed slab without the molecule, and

$${E}_{rlx}^{{H}_{2} O or {O}_{2}}$$

refers to the total energy of the isolated relaxed molecules. To define the adsorption of H₂O₂, the baseline of the corresponding molecule energy was the energy of

$${E}_{rlx}^{{H}_{2} O} + \frac{1}{2} {E}_{rlx}^{{O}_{2}} .$$

Throughout the experimental measurements, Ni particles interact with water and oxygen. Since all structural elucidations including XRD analysis shows that these particles are coated by a thin oxide layer (probably produced during the reaction of pyrene and metal salts at T>500° C.), we considered the NiO surface as a suitable substrate to represent the exposed surface of the Ni particles. To elucidate the binding configurations and the surface interaction between water and oxygen over the particle surface, each molecule was initially placed over several different positions above the surface and allowed to relax together with the surface atoms of Ni and the oxygen.

The three left columns of FIG. 14 present the adsorption energies and atomic configurations obtained for the most stable configuration of H₂O and oxygen (as a single molecule and as a dissociated one) over the NiO (001) surface. During the relaxation, the H₂O molecule left its initial position and relaxed above the surface with a relatively small adsorption energy of 0.07-0.10 eV. Much higher adsorption energy was computed for the oxygen. For the single molecule, depending on the relaxed configuration, the adsorption energy was between 1.8 and 2.1 eV, and for the dissociated molecule (i.e., for the adsorption of two atomic oxygen atoms), it was between 2.7 and 4.2 eV.

The right column (of FIG. 14) presents the adsorption energy and atomic configuration of a relaxed H₂O₂ molecule. This molecule over the NiO surface tends to dissociate into two —OH moieties strongly adsorbed to the surface. Such results were obtained when the initial configuration stat was an isolated H₂O₂ molecule over several locations on the surface and for the initial state of the dissociated molecule (to H₂O and O) as well.

From a thermodynamic viewpoint, an energy gain of 3 eV is obtained when the adsorbed H₂O reacts with the adsorbed O₂ to form 2·OH, of which 1 eV is due to oxygen dissociation

$$( i . e . , \frac{1}{2} {O}_{2} \to O )$$

and the other 2 eV is due to hydroxyl adsorption (H₂O+O→2·OH). Thus, as was found previously for gadolinium oxide^{37,38}, it seems that during the exposure of the NiO surface to oxygen and water, the surface may be covered by hydroxyls and afterward may react differently with the O₂ and the H₂O.

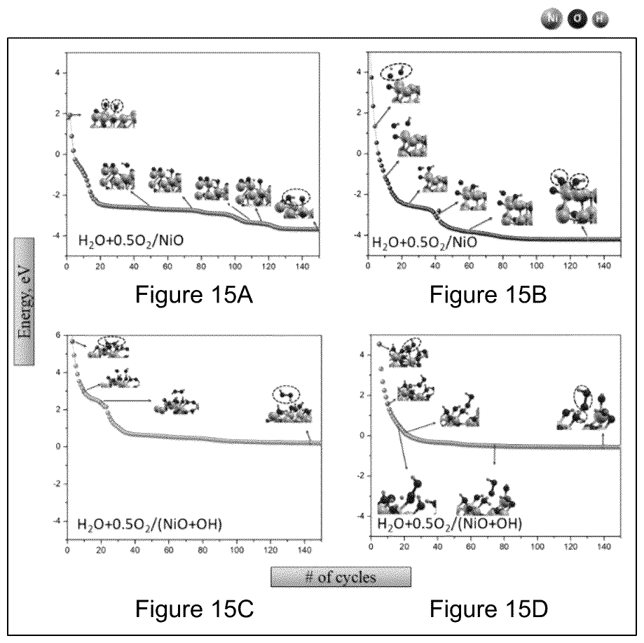

FIG. 15 shows the relaxation path of H₂O+0.5 O₂ over these two types of surfaces. As a result of the strong adsorption on the NiO surface (about 4 eV), the surface is expected to be fully covered by hydroxyls (FIG. 15A-15B). When the NiO surface is covered by hydroxyls, the adsorption energy of H₂O₂ over the NiO+OH surface is much lower (~0.1-0.3 eV), as shown in FIG. 15C. For the latter surface type, the most stable configuration takes place when the H₂O₂ molecule dissociates and reacts with the hydroxyl to create H₂O(H₂O₂+·OH→·OOH+·H₂O). FIG. 15D presents an energy gain of ~0.6 eV for this reaction.

In agreement with FTIR measurements, the DFT calculations (FIGS. 13-15) reveal that introducing water and oxygen to the NiO surface leads to the formation of hydroxyl groups on the surface of the electrocatalyst. Moreover, according to the computed adsorption energy, hydrogen peroxide seems relatively inert to NiOOH, supporting the observation that the catalyst is inactive towards HO₂⁻ reduction into water even at high overpotentials.

To supplement the investigation of the origin of the selective 2e⁻ ORR over Ni/C, the carbon-embedded nanoparticles from Ni₂₀Py synthesis were analyzed using a time-of-flight secondary ion mass spectrometry (ToF-SiMS) under negative polarity depth profiling conditions to probe for chemical fragments in Ni₂₀Py.

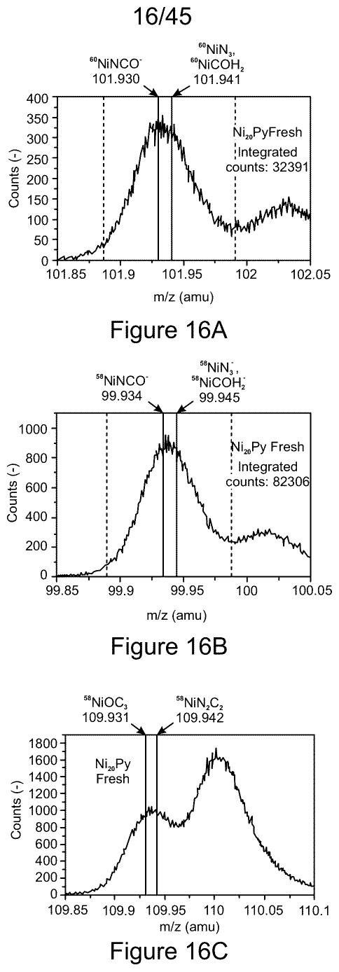

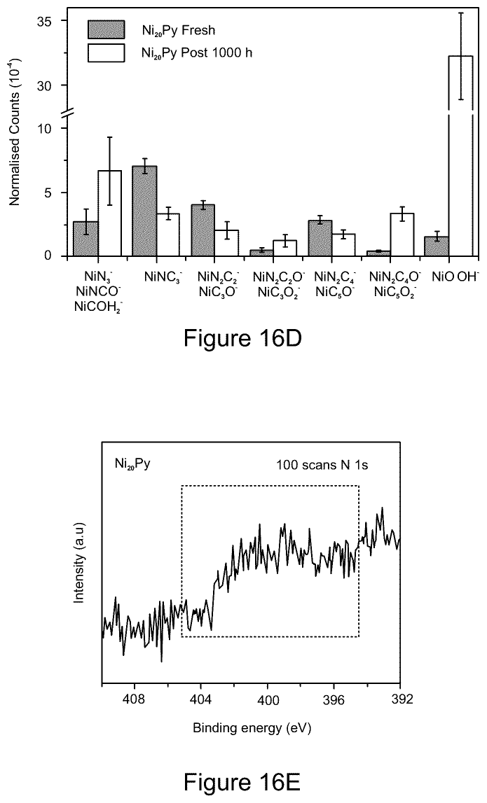

Interestingly, peaks in ToF-SIMS of Ni₂₀Py corresponding to NiNₓC_{y}⁻ or NiNₓ₋₂Cₓ₊₁O_{z+1}⁻ fragments were found (FIG. 16). The natural isotopic ratio of ⁶⁰Ni/⁵⁸Ni equals 0.385. The integrated counts of Ni₂₀Py for ⁶⁰NiN₃⁻/⁵⁸NiN₃⁻ and ⁶⁰NiNCO/⁵⁸NiNCO is 32391/82306=0.394 (FIGS. 16A-C). The near equivalent experimental and natural isotopic ratio of these fragments confirms their assignment relates to a Ni species. Based on the resolution of ToF-SIMS, NiNₓC_{y}O_{z}⁻ fragments cannot be deconvoluted from fragments of NiNₓ₋₂C_{y+1}O_{z+1}⁻. Therefore, both fragments are considered. Such fragments in ToF-SIMS have previously been confirmed as corresponding to single atom Ni—Nₓ sites. The “Fresh” sample is the “as synthesized” Ni/C material deposited on a carbon cloth before operation and the “Post 1000 h” sample is the same material after electrochemical operation as an electrocatalyst in basic environment (6 M KOH).

The analysis summary graph, FIG. 16D, depicts significant amount of NiNC₃⁻ and other NiNₓC_{y}⁻ fragments, which indicate the presence of chemical bonds between the metal atom and C from the carbon matrix and the Lewis base N coordinating atom (originating from the NO₃⁻ anion in the precursor salt), thus demonstrating the application of this method for formation of single-atom catalytic sites. To further confirm the presence of N moeities, a 100 scan XPS spectra was carried out (FIG. 16E) in the binding energy region of N is for Ni₂₀Py. Given the low nitrogen content employed in the synthesis (which arises from the NO₃⁻ groups in Ni(NO₃)₂·6H₂O), accurate fitting of the different binding energies is not possible. However, this qualitatively-determined nitrogen content is high enough for the preparation of single atom electrocatalysts.

This measurement shows that the electrocatalytic activity in OH⁻(aq) environment forms during operation nickel oxyhydroxide sites (NiOOH⁻ fragments in the ToF-SiMS). Therefore, the demonstrated efficient, highly stable, catalyst relies on NiNₓCy single sites and Ni(OH)₂ or NiOOH (in alkaline environment) engulfed in crystalline carbon (in accordance with the DFT calculations).

HO₂⁻ Oxidation on Ni₂₀Py Catalyst.

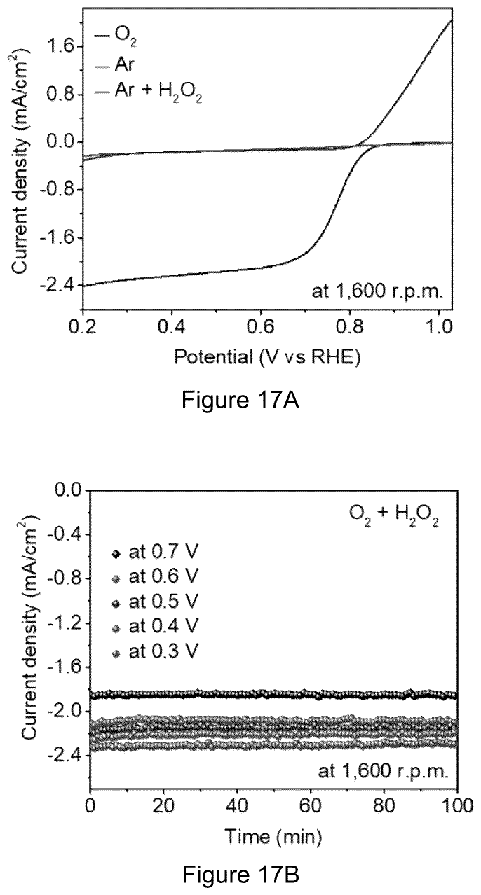

To further show the high selectivity and stability of Ni₂₀Py for hydrogen peroxide formation, the electrochemical reaction was examined in 0.5 M KOH with 5 mM of H₂O₂. Under Ar, no electrochemical activity can be observed. At the same time, in a combination of Ar atmosphere and hydrogen peroxide in the solution (Ar+H₂O₂), only anodic currents are visible, corresponding to the hydrogen peroxide oxidation reaction (POR, FIG. 17A). Long-term tests at different potentials in the presence of both O₂ and H₂O₂ show high stability and selectivity towards ORR, where the presence of H₂O₂ (added before the reaction to the reaction vessel) does not hurt the performance (FIG. 17B).

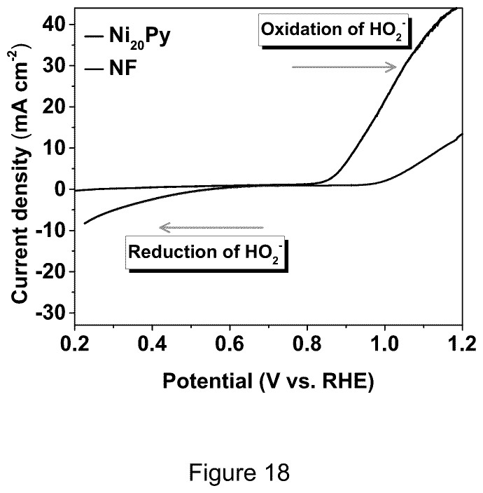

FIG. 18 and Table 1 show that using Ni foam (NF) as the electrode requires a potential of ~1.15 V to achieve a current density of 10 mA cm⁻²; this potential is higher than that of Ni₂₀Py (~0.92 V). Moreover, whereas at 0.92 V Ni₂₀Py reaches j=10 mA cm⁻², the Ni foam current density is close to zero. Therefore, the POR activity over Ni foam is much lower than the POR activity of Ni₂₀Py. This fact shown that a Ni surface (even if exposed to an OH-environment) does not allow the same activity towards POR. Moreover, FIG. 18 exemplifies that the demonstrated Ni/C material does not reduce HO₂⁻ (negligible current density in the cathodic direction) while a NF does.

TABLE 1
Electrochemical parameters from FIG. 18

| | Electrode onset | Overpotential |
|---|---|---|
| | potential | (V) |
| Electrode | (V) vs. RHE | @10 mA cm⁻² |
| Ni₂₀Py | 0.84 | 0.92 |
| NF | 0.97 | 1.15 |

### Example 4: Custom-Made Two-Compartment H-Cell Electrolytic Device

The catalyst's performance was examined in a divided H-cell using Pt as the counter electrode, the catalyst loaded on a 1 cm² carbon paper as the working electrode, saturated Ag/AgCl as the reference electrode, and an anion exchange membrane (FIG. 19A). A custom-made two-compartment H-cell electrolytic device (FIG. 19A) was built to evaluate the scalability of HO₂⁻ synthesis.

This cell allows synthesizing HO₂⁻ at high concentrations and volumes. The anode (Pt mesh) compartment is separated from the cathodic compartment (2e ORR) by an anionic exchange membrane (Fumasep FAS-30, Fuelcell store, USA) for ions transportation, whereas the reference electrode sits in the cathodic compartment. A Ni₂₀Py catalyst ink (2 mg of catalyst, 980 μL of isopropanol, and 20 μL of 5 wt. % Nafion solution) was prepared. Following ultrasonication for 2 h to form a uniform dispersion, the ink was drop cast (250 and 500 μL) onto carbon paper (TGP-H-60, Toray, 1×1 cm² catalyst area) and dried under an infrared lamp; the activity was optimized with different amounts of catalyst loading (~0.5 and 1.0 mg cm 2, FIG. 19B). The catholyte and anolyte were both 0.5 M KOH aqueous solutions (30 mL). When evaluating the stability of the electrocatalysts and the production of HO₂, a continuous flow of O₂ was introduced into the cathodic compartment (15 mL min⁻¹).

There was a slight shift in the onset potential when a higher loading was used (1 mg cm⁻²) compared to a loading of 0.5 mg cm⁻², while bare carbon paper showed no activity (FIG. 19B). Importantly, the high selectivity is due to the suppressed reduction of HO₂⁻ to OH⁻ (i.e., the peroxide reduction reaction, PRR) within a large voltage window (0.2 to 0.8 V, FIG. 17A).

The Ni₂₀Py catalyst is remarkably stable during hydrogen peroxide production at a constant voltage of 0.6 V vs. RHE (ca. −39 mA cm⁻²), at which a 97.3% current density retention rate is obtained after a 100 h chronoamperometric (CA) continuous test (FIG. 19C).

The accumulated hydrogen peroxide amount was examined every 10 h and plotted vs. time, which gave an excellent linear fit (R²=of 0.99) at a rate of 0.64±0.05 mmol h⁻¹ over the 100 h test period (FIG. 19C), and an average FE of 94%, indicating the high efficiency of the catalyst (FIG. 19D). All these electrochemical characterizations amount to net energy spend of

$$143.5 kJ {mol}_{{H}_{2} {O}_{2}}^{- 1} .$$

The electrocatalyst has a low energy spend.

### Example 5: Peroxide Producing Device Example: An ORR Flow-Cell

To commercialize the catalyst, relatively high currents are required at reasonably low potentials. A custom-made ORR flow-cell (FIG. 20) was built, where the anode (Ni foam) is separated from the cathode by an anion exchange membrane, while the reference electrode sits between them. The cathode was made from a 2.89 cm⁻² gas-diffusion-layer (GDL) carbon sheet, where one side was hydrophobic (pre-coated with Nafion and a fluoropolymer as PTFE), and the other was loaded with 0.5 mg cm⁻² of the catalyst (the catalyst side faces the electrolyte). Oxygen is bubbled into the cell without interacting with the electrolyte, instead interacting directly with the hydrophobic side of the GDL; thus, there is no dependency on O₂ solubility in water, and the catalyst directly adsorbs it.

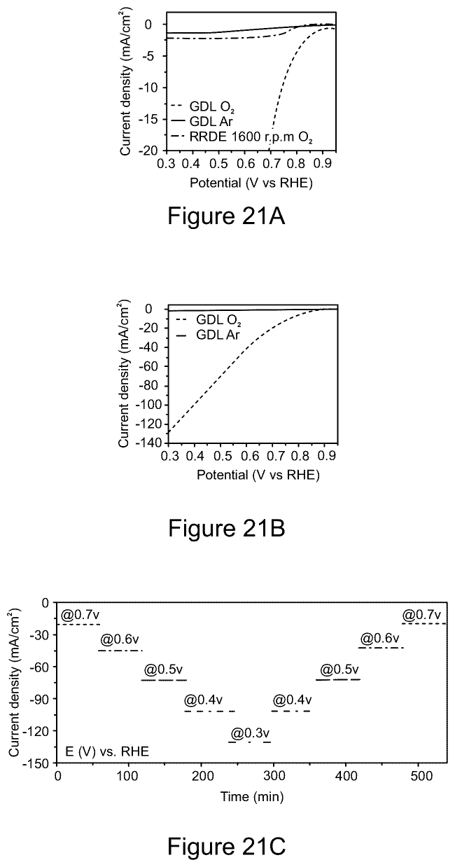

This setup (referred to as GDL) unlocks the possibility of achieving very high current density values, almost ten times greater than those achieved in the RRDE setup; for example, at 0.7 V vs. RHE, the current densities were −2 and −18 mA cm⁻² in the RRDE and GDL setups, respectively (FIGS. 21A and 21B). At higher potentials, the difference between the two setups is increased even further; the GDL setup reached −130 mA cm⁻² at 0.3 V vs. RHE, while RRDE gave only −2.2 mA cm⁻² at the same conditions since a diffusion-limiting factor still exists (FIGS. 21B and 21A, respectively). Chronoamperometry at different potentials reveals exceptionally high stability (FIG. 21C). The potential was shifted in a stepwise manner of 0.1 V h⁻¹, starting from 0.7 V until reaching 0.3 V; after 5 h, the potential was increased back to 0.3 V at a 0.1 V h⁻¹ rate. At each potential, the catalyst performed admirably, with no changes to current density values, even when shifted back to previously explored potentials.

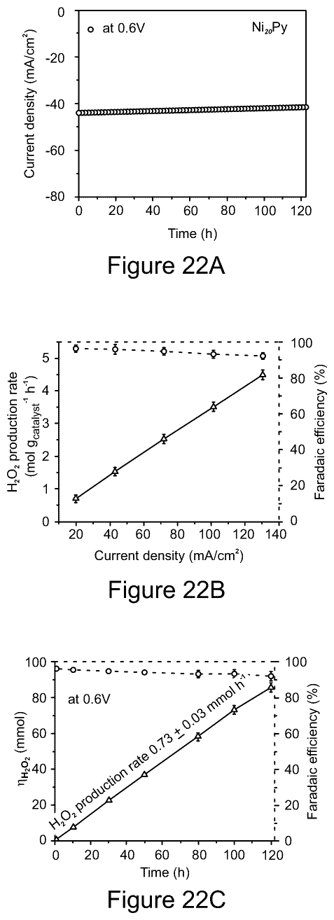

The catalysts' long-term stability and hydrogen peroxide production in the GDL setup was tested at 0.6 V (FIG. 22A). The current density value, in the beginning, was −43.6 mA cm⁻², while in the end, it was −41.5 mA cm⁻². The specific hydrogen peroxide production rate (mol g_{catalyst}⁻¹ h⁻¹) at different currents indicates the catalyst's performance. In the case of Ni₂₀Py, it increases linearly (FIG. 22B), demonstrating the remarkable efficiency of this catalyst together with an average FE ca. 95% (FIG. 22B). Industrial systems that produce hydrogen peroxide would typically operate at a constant voltage for prolonged times; therefore, the system was operated at 0.6 V for 2 h. The total amount of hydrogen peroxide produced was about 85 mmol with a linear production rate of 0.73±0.03 mmol h⁻¹ maintaining an average FE of 96% (FIG. 22C).

### Example 6: Quantification of HO₂⁻ Production and Measurement of Faradaic Efficiency

HO₂⁻ production was tested in the H-cell electrolytic device configuration to determine stability and accurate peroxide production yields. The cathode and anode compartments were both filled with 30 mL of 0.5 M KOH aqueous electrolyte and then saturated with O₂. The concentration of HO₂⁻ (C_{HO2}⁻) was determined by titration with cerium sulfate, Ce(SO₄)₂, according to the reaction:

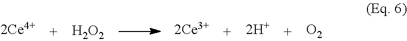

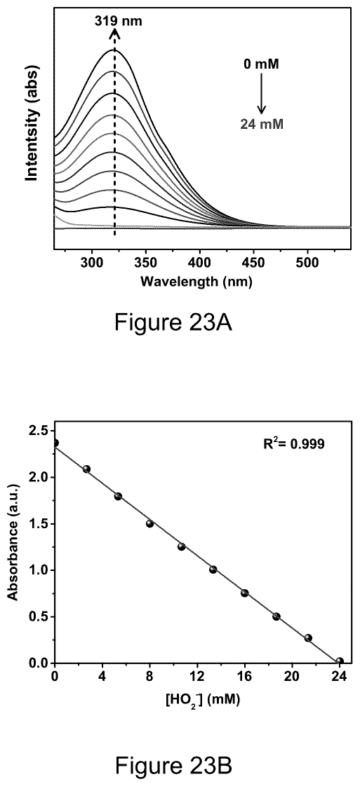

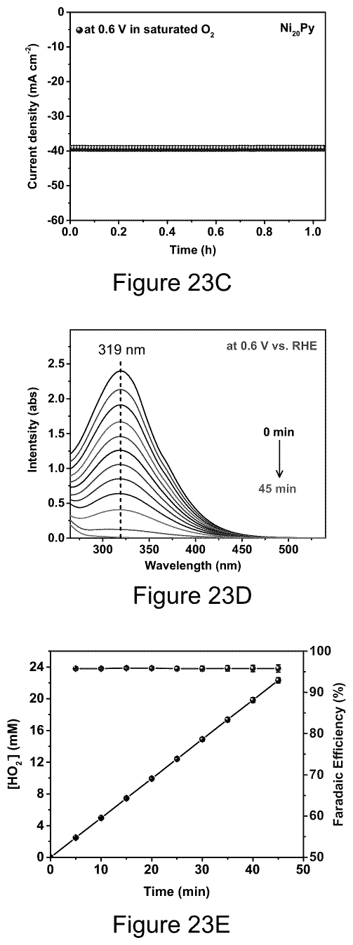

The yellow Ce⁴⁺ solution reacts with the peroxide and generates the colorless Ce³⁺. In this experiment, a 1 mM Ce(SO₄)₂ solution was prepared by dispersing 83.0 mg Ce(SO₄)₂ in 250 mL of 0.5 M H₂SO₄ aqueous solution. Then ultraviolet-visible absorbance spectrum (UV-vis; Cary 100 spectrophotometer) was used to determine the calibration curve between the titrated Ce(SO₄)₂ solutions and various standard concentrations of HO₂⁻ solutions (C_{HO2}⁻=0, 4, 8, . . . , 24 mmol L⁻¹) at 319 nm, where A=2.32-0.259×C (mmol L⁻¹), (R²=0.99) (FIGS. 23A-23B).

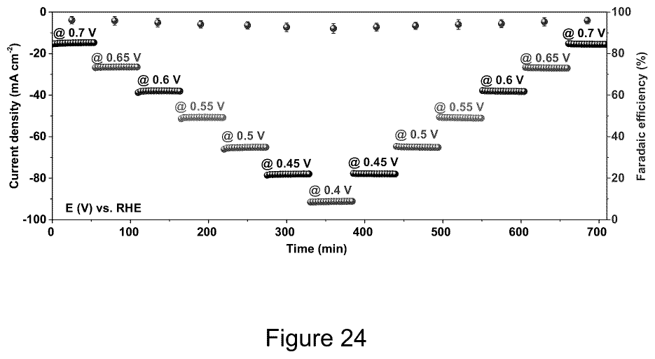

Chronoamperometry with an applied voltage of 0.6 V vs. RHE at room temperature for prolonged duration of more than an hour (FIG. 23C) shows stable current, and the UV-vis spectrum during the first 45 min is shown in FIG. 24D and was used to determine the amounts of produced peroxide yield.

The Faradaic HO₂⁻ efficiency (FE) was calculated from the HO₂⁻ yield against the total quantity of charge passed:

$${HO}_{2}^{-} ( FE ; \% ) = 2 CVF / Q \qquad ( Eq . 7 )$$

where C is the HO₂⁻ concentration (mol L⁻¹), V is the volume of electrolyte (L), F is the Faraday constant (96,485 C mol⁻¹), and Q is the passed charge amount (C). The passed charge amount is calculating by integrating the measured current over time—from 0 to t—time of polarization at a given applied potential—according to:

$$Q = {\int }_{0}^{t} I ( t , {E}_{applied} ) d t \qquad ( Eq . 8 )$$

The results of this experiment are summarized in FIG. 23E showing the linear increase of peroxide concentration (the result of ORR) over time at a constant FE exceeding 95%.

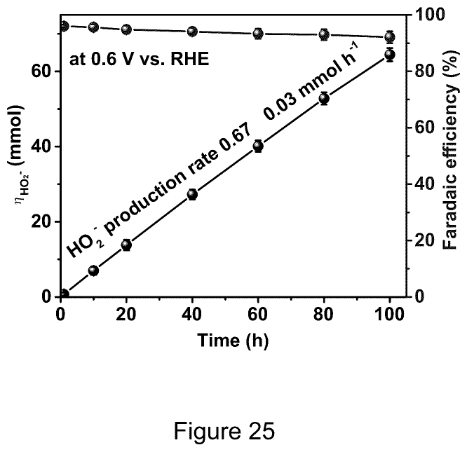

To further evaluate the activity of the Ni₂₀Py catalyst and assess its stability during practical HO₂⁻ production, a fixed H-cell electrolytic device cell with a constant volume of O₂-saturated electrolyte was used and current densities and the corresponding FE values at different potentials (from 0.7 V down to 0.4 V and back to 0.7 V vs. RHE) were measured over time (FIG. 24). Constant potential testing at 0.6 V vs. RHE was carried out for −100 h to evaluate the stability of the catalyst during HO₂⁻ production, with HO₂⁻ in the electrolyte being quantified at various time intervals using the Ce⁴⁺ titration method, and the Faradaic efficiency was subsequently estimated. During the experiment, the HO₂⁻ production rate was estimated to be 0.67±0.03 mmol h¹, which means a specific rate of ~670±30 mmol h⁻¹ g⁻¹ and a Faradaic efficiency of >92% (FIG. 25).

### Example 7: Hydrogen Peroxide Sensing

The synthesized materials, which have electrocatalytic properties can also be implemented as catalysts for the hydrogen peroxide oxidation reaction (POR), which is helpful for hydrogen peroxide sensing in biological, food, and pharmaceutical industries. Cyclic voltammetry (CV) curves of the electrocatalyst in 1 M KOH with 2 mM H₂O₂ and without H₂O₂ in an Ar-saturated environment demonstrate the electrocatalyst's sensitivity to hydrogen peroxide. The onset potential of the anodic current (iₐ) is 0.8 V reaching as high as 0.154 mA at 0.93 mV (FIG. 26A). The analysis of peak current vs. square root of scan rate (FIG. 26D) shows linearity over a wide range of scan rates, indicating a diffusion-controlled process. The logarithmic plot of the peak current vs. scan rate has a calculated slope of ~0.5 (FIG. 26E), also demonstrating a diffusion-limited regime.

POR process on Ni₂₀Py catalyst surface:

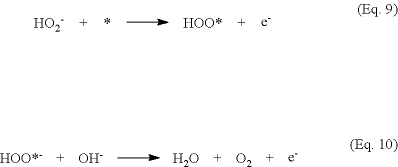

The half-wave potential (E_{1/2}), the average between iₐ and the cathodic current (i_{c}) is 0.8 V, coinciding with the electrocatalyst's onset potential toward POR.

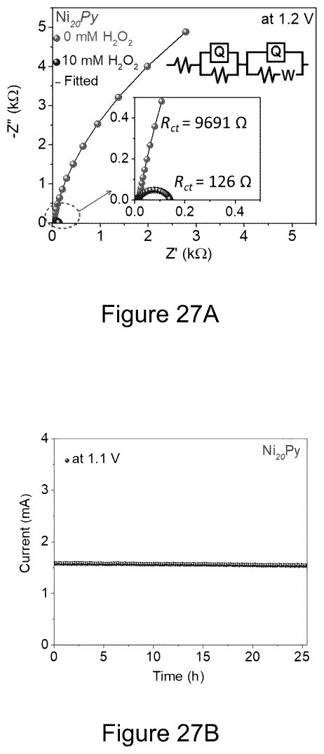

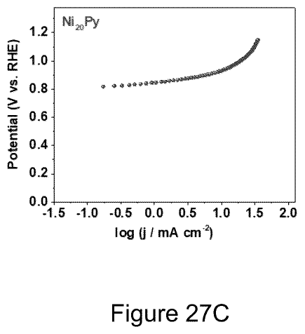

A sensor is required to respond linearly with the amount of analyte. CV curves of the electrocatalyst show the linear increase of iₐ at different hydrogen peroxide concentrations (0-8 mM), all detected at an onset potential of 0.8 V (FIG. 26B). Plot of the Randles-Sevcik equation (FIG. 26D, current density vs. the square root of scan rate) exhibits a linear slope, demonstrating the excellent adsorption of hydrogen peroxide to the electrode's surface, which is not hampered at high scan rates due to the decrement of the diffusion layer. The logarithmic plot of current density vs. scan rate (FIG. 26E) shows a slope of 0.73, indicating that the kinetics are governed by surface-controlled Faradaic reactions (slope=1) and semi-infinite diffusion processes (slope=0.5). Moreover, the electron transfer number is close to two, indicating a 2e POR process (FIG. 26F). To calculate the charge transfer resistance (R_{ct}) for POR, electrochemical impedance spectroscopy (EIS) was performed at 0.95 V vs. RHE (FIG. 27A). In the equivalent electrical circuit used for the fitting (FIG. 27A, inset), a series RC circuit combination is used. The parallel combination of Q₁ and R₁ in the first RC circuit (from the left) represents the geometrical capacitance of the catalyst and the resistance of the film layer⁷⁻⁹. In series with the first RC parallel circuit, the second RC, which is composed of a constant phase element Q₂, a resistance R₂ (R_{ct}), and a Warburg impedance Z_{w} element, which represent the interfacial capacitance, the charge transfer resistance, and the mass transport component of active species to and from the electrode surface, respectively. The EIS analysis shows an apparent change in the charge transfer resistance (R_{ct}) of 126 and 9691Ω in the presence of 10 mM H₂O₂ and without, respectively (FIG. 27A). Hydrogen peroxide is a powerful oxidizing agent; therefore, any sensor for it should withstand prolonged activity with no catalyst degradation. Chronoamperometry of the catalyst in 1 M KOH with 10 mM of H₂O₂ at 1.1 V does not indicate significant change in the current during 25 h (FIG. 27B). The lower Tafel slope (FIG. 27C) values indicate a faster rate of POR reaction kinetics on the electrocatalytic sites.

### The Exchange Current Density (j₀) Calculation.

The obtained exchange current density (j₀) was calculated using Eq. 11¹⁰⁻¹¹ from the EIS analysis (FIG. 27A). The number of electrons involved in the process was ~2e⁻ (n=2) and the surface area, A, is assumed to be the geometric area (0.125 cm²). Charge transfer resistance (R_{ct}) values were extracted from the Nyquist plots. The analysis is summarized in Table 2.

$${j}_{0} = \frac{RT}{{nFAR}_{c t}} \qquad ( Eq . 11 )$$

TABLE 2
Comparison of performance metrics for POR on
Ni₂₀Py and NF (data extracted from FIG. 27).

| | | |
|---|---|---|
| | Charge | Exchange |
| | transfer | current density |
| Electrode | resistance (R_{ct}) | (j₀) (mA cm⁻²) |

| | | | |
|---|---|---|---|
| Ni₂₀Py | 0.12 | kΩ | 0.815 ± 0.010 |
| Nickel | 9.7 | kΩ | 0.011 ± 0.005 |
| foam (NF) | | | |

### Example 8: H₂ Production Using an Aqueous H₂O₂ Electrolyzer

Nowadays, hydrogen is frequently formed using electrolyzers from water. One half-cell consists of a hydrogen evolution reaction (HER, 0 V vs. RHE), while the other half-cell reaction consists of the oxygen evolution reaction (OER, 1.23 V vs. RHE). Usually, the electrolyzers contain an alkaline media to improve the rather sluggish OER kinetics at cell voltages>1.5 V. To surpass this issue; the half-cell of OER was exchanged for the POR, which has a lower required potential of only 0.695 vs. RHE (see diagram in FIG. 28A). As a result, the needed cell voltage to produce hydrogen is lowered to 0.9 V. All relevant electrochemical characterizations were discussed above. Chronopotentiometric (CP) measurements (FIG. 28B) and operando ATR-FTIR spectroscopy tests (FIG. 28C) carried out at different potentials (anodic scans) shows the linear production of H₂ (on the cathode) and observed OOH* band gradually increases as the potential is increased from 0.8 V to 1.1 V vs. RHE in the presence of 1 mM HO₂⁻ (FIG. 28C, POR) on the anode. This trend suggests that the mechanism of POR on Ni₂₀Py is a two-electron, two-step process and it involves the adsorption of HO₂⁻ and its subsequent oxidation to OOH* (hydroperoxyl intermediate) and then O₂. The adsorbed hydroperoxyl is hence the key intermediate (OOH*) for POR on the anode, while H₂ evolves on the cathode.

The electrocatalyst was examined in a 2-electrode H-cell setup, where Pt was the cathode, the developed electrocatalyst on a carbon paper electrode (0.5 mg cm⁻¹ loading) as the anode, and an anion exchange membrane in 1 M KOH with 100 mM H₂O₂. CP measurement at 10 mA cm⁻² shows a stable cell voltage of 0.85 V for 16 h (FIG. 28B). The FE of HER in this cell at 16 h is 99.9%, showing the high activity of our material towards POR. A slight increase in cell voltage is detected after close to 16 h, as hydrogen peroxide concentration should almost not exist. The electrocatalyst mounts to a thermodynamic electricity power consumption for H₂ production via H₂O₂ electrolysis of only

$$21.47 kWh {kg}_{{H}_{2}}^{- 1} ,$$

which is 65.0% that of water electrolysis

$$( 32.96 kWh {kg}_{{H}_{2}}^{- 1} ) ,$$

rendering this approach suitable for remote areas with constrained power supply.

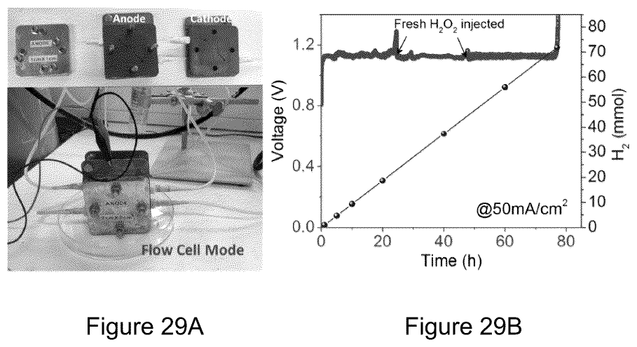

The electrocatalyst long term stability was examined in a 2-electrode cell in flow mode (FIG. 29A), where Pt mesh was the cathode, the developed electrocatalyst on a carbon paper electrode (0.5 mg cm⁻² loading) as the anode, and an anion exchange membrane using as a separator for the process and the flow electrolyte contains 1 M KOH with 0.3 mM H₂O₂. CP measurement at 50 mA cm⁻² shows a stable cell voltage of ~1.1 V for 77 h (FIG. 29B) and the concentration of H₂O₂ injected with respect to the time interval. The FE of HER in our cell at 77 h is close to 99.9%, showing the high activity and durability of our material towards POR also in a flow-cell configuration.

### Example 9: Rechargeable Metal-Peroxide Battery

The following section discusses a certain metal-air battery implementation (M₂-air, where M₂=Zn). This is a general demonstration for any type of M₂-air (M₂=Zn, Al, Fe, Mg, and so forth) battery technology. Current metal-air batteries are constructed from 2 electrodes; during discharge, one half-cell constitutes M→Mⁿ⁺+ne⁻ (simple oxidation reaction), while the reduction half-cell is: O₂+2H₂O+4e⁻→4OH⁻. During charge, the metal cation (Mⁿ⁺) is reduced back to its metallic state (M), while the other half-cell is based on the energy-demanding OER, 4OH−→2H₂O+O₂+4e⁻. Replacing OER with a O₂/H₂O₂ redox reaction offers faster kinetics, resulting in high energy efficiency (FIGS. 30A and 30B). The metal-peroxide battery is described in FIG. 30A and FIG. 30B is a schematic representation of the suggested mechanism on the electrode surface (the cathode during discharge).

As discussed earlier, the developed electrocatalyst has shown bifunctionality for hydrogen peroxide formation (from oxygen, ORR) and POR. Therefore, a rechargeable M₂-H₂O₂ battery cell (in this example implementation M₂=Zn) was constructed using two electrode configuration from 1 cm² M₂ foil (anode) in 6 M KOH with 0.2 M zinc acetate and 1 cm² carbon paper coated with 1 mg cm⁻² loading of the electrocatalyst (cathode), separated by an anion exchange membrane (AEM). The electrolyte (6 M KOH) was saturated with 02 (FIG. 31) and volume of electrolytes of −15 mL for both compartments.

This configuration is henceforth abbreviated as zinc-peroxide battery (ZPB). The redox feature of Zn/Zn²⁺ (black line at more negative potentials) and O₂/HO₂⁻ (red line) with Ni₂₀Py (FIG. 32A) reveal a voltage gap between the two half-cells (the gap between the redox potentials) of ~1.3 V. The high reversibility of the electrochemical O₂/HO₂-reaction over Ni₂₀Py is evident from the cyclic voltametric response (FIG. 32A), and is enabled by at least two distinct active sites, one for 2e⁻ ORR (which involves single-atom NiNₓC_{y} sites and a NiOOH or Ni(OH)₂ surface) and one for the 2e⁻ POR (including NiO sites), (FIG. 12B). The i-V curve combined with a power density plot demonstrates a maximum power density of 135 mW cm⁻² at 210 mA cm⁻², similar to commercial Pt/C cathode, thus eliminating the need to use highly precious metal electrodes (FIG. 32B).

The rate performance of the ZPB was examined in a fixed capacity of 20 mAh cm⁻² at different current densities (FIG. 32C). The values of the round-trip energy efficiency (r/), which represents the ratio between the charge and discharge nominal voltages at fixed capacity, are plotted against the capacity at different current densities in FIG. 32D (see data in Table 3 and FIG. 33). At a current density of 2 mA cm⁻², the battery exhibits an ultra-low charge overpotential of 30 mV (1.28 V vs. Zn), whereas at a high current density of 50 mA cm⁻², it reaches a charge overpotential of 200 mV (1.48 vs. Zn), resulting in r/of 97.3% and 74.8%, respectively. The polarization graph of discharge (cathode polarization) and charging part (anode polarization) (FIG. 23E) allows measuring the voltage difference at the desired current density to quantify the energy efficiency of the battery with respect to the applied current density. The high efficiencies are maintained even various cycles at different current density values (FIG. 33) allowing i/calculation at fixed drawn capacity, showing the high reversibility and stability. The outstanding energy efficiency of 74.8% at a high current density of 50 mA cm⁻² with a fixed capacity of 20 mAh cm⁻², almost 3-fold higher than state-of-the-art Zn-air battery (operating at a much lower current density), which reaches approximately 30% efficiency at 4 mA cm⁻² at a fixed capacity of 8 mAh cm−

The cell voltages remain stable at the explored capacity values, and the cells show a low net energy loss (FIG. 32D). The charging potential 1.46 V at high current density (50 mA cm⁻²) is even lower than the theoretically required charging voltage of traditional Zn-air batteries (~1.65 V).

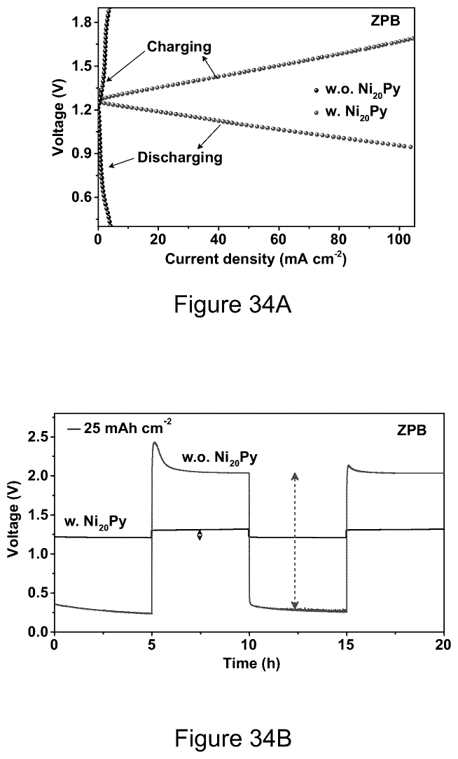

It was noted that without the bifunctional catalyst (Ni₂₀Py) the battery exhibits poor performance, FIG. 34. Therefore, the Zn—H₂O₂ battery (ZPB) represents a substantial leap in energy efficiency and capacity over existing Zn-air battery technology and even in the case of fully optimized bifunctional ORR/OER catalysts, the traditional Zn-air battery will not be able to reach the energy efficiencies of the demonstrated ZPB.

The highly reversible nature of the cathode due to the replacement of OER with POR is evident at prolonged operation at different current densities (FIG. 35A-FIG. 35C). Moreover, the discharge-charge profile (FIG. 35D, 5 h discharge followed by 5 h charge) at 50 mAh cm⁻¹ shows 100 mV voltage polarization (93% energy efficiency) along with a linear change in peroxide concentration.

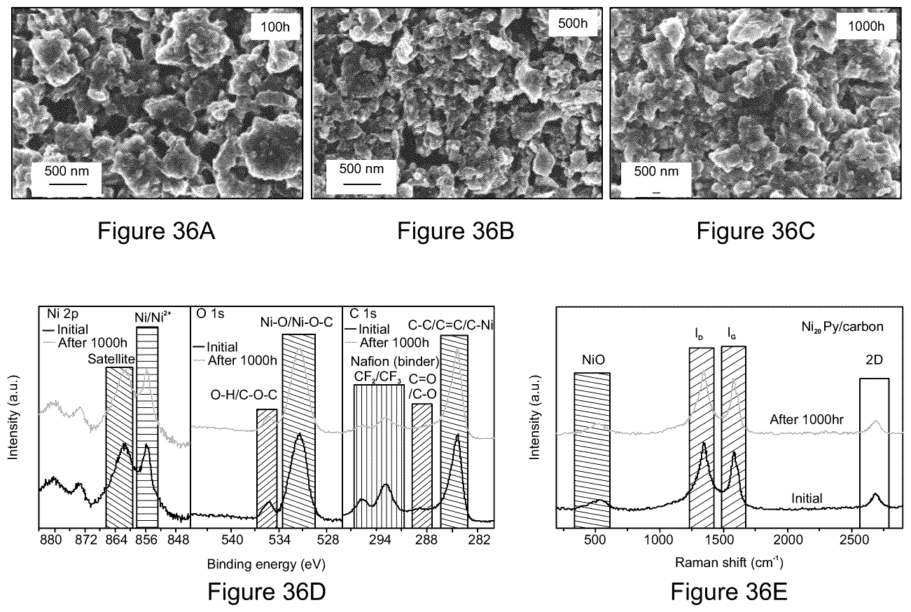

To test whether the battery is commercially viable, the performance was tested in a closed battery cell and maintained at a constant capacity of 25 mAh cm⁻² (FIG. 35B). In this closed cell, the achieved energy efficiency was 95% for 25 cycles (250 h), highlighting the high stability and performance of the designed electrocatalyst in such configuration. The long-term stability of the battery was examined at an areal capacity of 50 mAh cm⁻² (FIG. 35A) for 100 discharge/charge cycles (1000 h) at a current density of 10 mA cm 2. The Zn anode was replaced every 20 cycles (200 h), while the other parts (electrolyte, membrane, air cathode) were left in place. The cathode showed high stability and reversibility: it maintained an energy efficiency of ~92% throughout the entire measurement and retained 98.7% of the original energy efficiency after 100 cycles (FIG. 35A). HRSEM images, XPS, and Raman spectroscopy of the cathode post-cycling (discharging and charging) at different time intervals (10, 50, and 100 cycles) reveal no significant morphological or structural changes in the bifunctional air electrode catalyst as shown in FIGS. 36A-FIG. 36E.

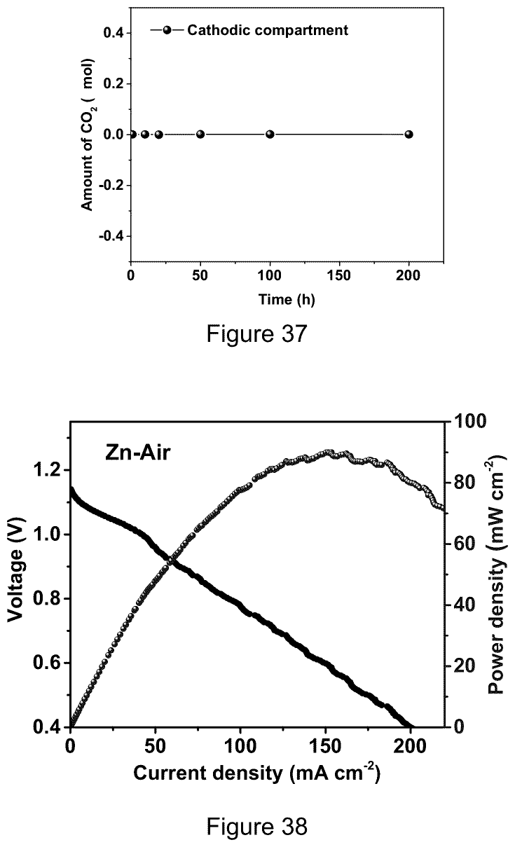

Furthermore, we detected no CO₂ formation during HO₂⁻ oxidation, confirming the high stability of the carbon in our catalyst (FIG. 37D). This emphasizes the excellent stability of the cathode during long-term cycling at high capacities, an essential feature for commercial ZPB devices.

### Example 10 Sealed-Cell ZPB Vs. Atmospheric-Air Operation

The shown ZPB devices were tested in a sealed battery with filled O₂(g) (0.5 mmol of O₂) in the air electrode compartment with the cell maintained at a constant capacity (FIG. 35). We also demonstrate the ZPB operation for a practical device in atmospheric air. The battery displays a power density of −90 mW cm⁻² at a peak current of ~160 mA cm⁻² (FIG. 38). Further long-term performance for >800 h (80 cycles) at a fixed capacity of 15 mAh cm⁻² (j=3 mA cm⁻²) (FIG. 35C) showed high stability and reversibility: it maintained an energy efficiency of ~83% throughout the entire measurement and retained ~96% of the original energy efficiency after the >800 hours of continuous test (FIG. 35C).

The formation and consumption of HO₂⁻ during the operation of the ZPB were validated by monitoring the change in HO₂⁻ concentration in the electrolyte (samples from the electrolyte in the cathode compartment were removed at different times and added to Ce(SO₄)₂ titrant solutions, followed by optical absorbance determination of the experimental concentration of HO₂⁻). The obtained measurements show that the HO₂⁻ concentration in the electrolyte increases steadily during discharge (2e ORR) and decrease steadily during charge (POR); the measured Faradaic efficiency is 95.3%±0.8%. The charge-discharge study was performed at 50 mAh cm⁻² (FIG. 35D, 5 h discharge followed by 5 h charge). The highly reversible nature and ultra-low charging overpotential of the air electrode are due to the substitution of OER with POR, which has much faster electron kinetics and a 100 mV voltage polarization (92% energy efficiency).

### Example 11: Modification with Heteroatoms for MXₓ/C Composites (in this Example X=P) Via Triphenylphosphine (PPh₃) Addition to the Pyrene PAH (Pyr)

Metal precursors, M(NO₃)₂·xH₂O (M=Ni, Co, Fe, Cu; or their mixtures), pyrene (Pyr) and triphenylphosphine (PPh₃) were used as received without drying. In each synthesis batch, a mixture of PPh₃:Pyr in a molar ratio of 1:1 was ground and mixed using an agate mortar and pestle with a mass of transition-metal nitrate salt (or a mixture of salts) equivalent to form a total 30 wt. % net metal in Pyr+PPh₃ synthesis melt (designated as M₃₀PyrPPh₃). Higher phosphides were prepared in the same manner with the difference of changing the molar ratio between Py and PPh₃.

In a typical synthesis, a salt (or salts mixture) consisting of 1.00 g of net metals was mixed with 1.0159 g of Pyr and 1.3175 g of PPh₃. The mixture was placed in covered ceramic crucible and calcined under N₂ environment in a muffle furnace. The calcination program included two steps: first, heating at a rate of 2.5° C. min⁻¹ to 300° C. with a dwell time of 2 h for complete melting and mixing, to form a molten-state intermediate phase. In the second step, the mixture was heated at a rate of 2.5° C. min⁻¹ to 750° C. with a dwell time of 4 h at the target T to allow complete reaction, i.e., phosphides formation, pyrene carbonization, graphitic carbon matrix formation, and by-products evaporation.

After natural cooling from 750° C. to room temperature, the products were ground using an agate mortar and pestle, ball-milled (dry milling a using Fritsch Pulverisette 7 planetary ball mill with 1 mm ZrO₂ balls in 20 mL vessel, 45 min at 1000 rpm), and thoroughly washed by rinsing stepwise with 2 M HCl, deionized water and EtOH (each wash duration was 24 h in a 250 mL volume) to remove soluble unreacted precursors or by-products (mainly triphenylphosphine oxide and transition-metals compounds as oxides or zero-valent metals). The products were finally dried under vacuum for 24 h.

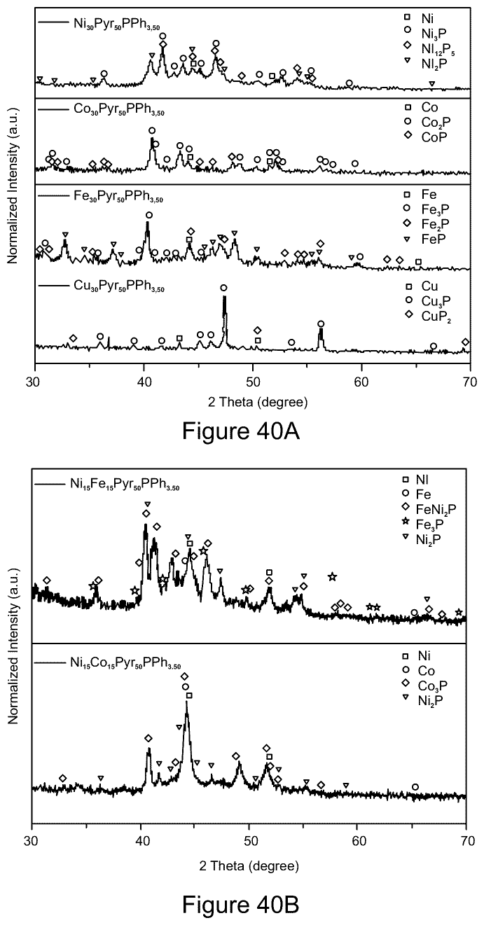

XRD patterns (FIG. 39A) of the final materials with varying molar ratios of 1:0, 3:1, 1:1, 1:3, and 0:1 between Pyr and PPh₃ indicate that when only Pyr is used, metallic Ni nanoparticles are formed while in its absence and when only PPh₃ was used in the melt both Ni nanoparticles and Ni₃P are formed. Varying the molar ratio between Pyr and PPh₃ allows controlling the amount of the synthesized Ni₃P phase. SEM images of Ni₃₀PPh₃ and Ni₃₀PyrPPh₃ (FIG. 39B and FIG. 39C, respectively) show apparent morphological differences as Ni₃₀PPhe₃ has uniformly distributed Ni₃P nanoparticles on a bulk carbon particle. In contrast, Ni₃₀PyrPPh₃ shows petal-like bulk carbon particles with Ni₃P nanoparticles on their sharp edges. HRTEM images (FIG. 39D, and FIG. 39E) of Ni₃₀PyPPh₃ demonstrate the formation of Ni and Ni₃P nanoparticles in the 10-100 nm range. This synthesis can be expanded to other metals (FIG. 40), such as iron (Fe), cobalt (Co), and copper (Cu) as well as to binary metal phosphides.

### Example 12: Catalyst Applications—Electrochemical Nitrate Reduction Reaction (NO₃RR) into Ammonia (NH₃)

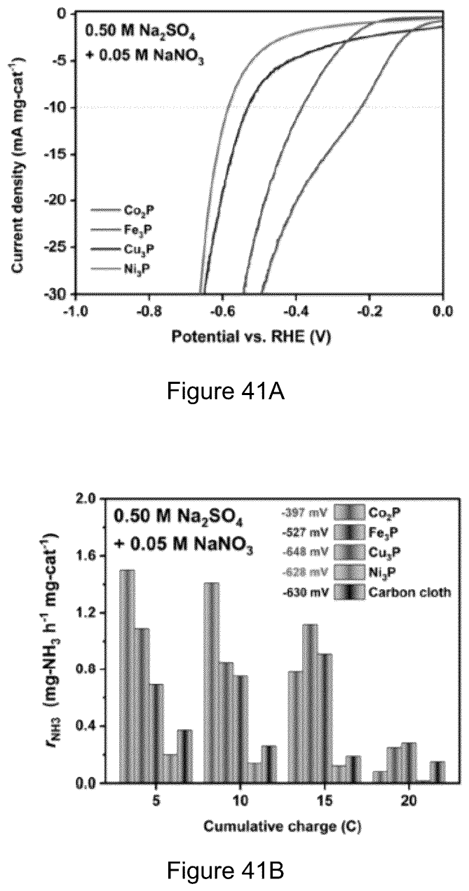

Transition-metal phosphides (TMPs) in carbon matrix were used to perform the overall reaction: NO₃⁻+6H₂O+8e⁻→NH₃+9OH⁻. These electrochemical nitrate reduction reaction (NO₃RR) experiments were conducted in glass H-cell setup, with 40 mL volume of each compartment, under Ar atmosphere (>99.999%, <2 ppm O₂ and <5 ppm N₂, Maxima Co., Israel). The cathodic compartment, containing the working and reference electrodes, was filled with 0.5 M Na₂SO₄+0.05 M NaNO₃ and the anodic compartment, containing the counter electrode, was filled with 0.5 M Na₂SO₄. The working electrode consisted of a hydrophobic carbon-cloth (1 cm×2 cm) substrate drop-coated with the phosphide electrocatalyst, using a 4 vol. % Nafion™ in 1:1 (vol:vol) ethanol:water ink, to a total loading mass 0.5 mg catalyst (i.e., 0.5 mg cm⁻²). An aqueous Ag/AgCl reference electrode filled with saturated KCl solution was used as reference electrode. A platinum (Pt) plate (1 cm×1 cm) was used as a counter electrode. Nafion™-117 membrane (0.007 in thickness) was used as proton exchange membrane, separating the cathodic compartment from the anodic compartment, to avoid Pt or O₂ contamination of the catholyte. The membrane was pretreated by stepwise rinsing in 5 wt. % H₂O₂ solution, ultra-pure water, 5 wt. % H₂SO₄ and ultra-pure water, all at 80° C. for 1 hour each, to eliminate organic contaminations and activate the membrane. NH₃ yield was calculated by the following equation:

$$Yield ( {NH}_{3} ) = ( C \times V ) / ( m \times t ) \qquad ( Eq . 12 )$$

where C is the concentration of NH₃(aq), V is the volume of the electrolyte, m is the mass of loaded catalyst, and t is the reaction time. Faradaic efficiency (FE) for NH₃ production was calculated by the following equation:

$$Faradaic efficency = [ C \times V \times F \times n ) / Q ] \times 100 \% \qquad ( Eq . 13 )$$

where C is the concentration of NH₃(aq) in the electrolyte, V is the volume of the electrolyte, n is the number of electrons transferred (for the described NO₃RR reaction, n=8), F is the Faraday constant (96485 C mol⁻¹), and Q is the total charge passing the electrode. NH₃/NH₄⁺ concentration in the electrolytes was analyzed by colorimetry using the indophenol method, utilizing the reaction of ammonia and hypochlorite to form indophenol with a distinct absorbance in the visible ca. 650-660 nm. The results are summarized in FIG. 41, showing the cathodic NO₃RR reaction using TMP (M=Co, Fe, Cu, Ni) and the calculated specific NH₃ production rates (r_{NH3}) on the four TMPs and a bare carbon cloth as the reference. All four catalysts are highly electroactive, reaching above 30 mA mg-cat⁻¹ at moderate potentials of down to −0.7 V vs. RHE. The NO₃RR performance is composition-dependent, with the best r_{NH3} measured for Co₂P, exceeding 1.5 mg-NH₃ h⁻¹ mg-cat⁻¹, with FE over 90%. Fe- and Cu-phosphides are also active towards NO₃RR, with values in the 0.7-1.1 mg-NH₃ h⁻¹ mg-cat⁻¹ and 60-70% FE. Ni₃P is less active for this reaction due to its high reactivity towards the competing H₂ evolution reaction. These results show the promise of the synthesized materials towards NH₃ production at high FE and high rates ca. 0.1 mol-NH₃ h⁻¹ g-cat⁻¹.

### REFERENCES

1. H. J. Monkhorst, J. D. Pack, Special points for Brillouin-zone integrations. Phys. Rev. B. 13, 5188-5192 (1976).
2. J. P. Perdew, K. Burke, M. Ernzerhof, Generalized gradient approximation made simple. Phys. Rev. Lett. 77, 3865-3868 (1996).
3. Q. Zhang, X. Tan, N. M. Bedford, Z. Han, L. Thomsen, S. Smith, R. Amal, X. Lu, Direct insights into the role of epoxy groups on cobalt sites for acidic H₂O₂ production. Nat. Commun. 11, 4181 (2020).
4. E. Jung, H. Shin, B. H. Lee, V. Efremov, S. Lee, H. S. Lee, J. Kim, W. Hooch Antink, S. Park, K. S. Lee, S. P. Cho, J. S. Yoo, Y. E. Sung, T. Hyeon, Atomic-level tuning of Co—N—C catalyst for high-performance electrochemical H₂O₂ production. Nat. Mater. 19, 436-442 (2020).
5. X. Shi, S. Back, T. M. Gill, S. Siahrostami, X. Zheng, Electrochemical Synthesis of H₂O₂ by Two-Electron Water Oxidation Reaction. Chem. 7, 38-63 (2021).
6. D. Su, M. Ford, G. Wang, Mesoporous NiO crystals with dominantly exposed {110}reactive facets for ultrafast lithium storage. Sci. Rep. 2, 924 (2012).
7. A. R. Kottaichamy, S. Begum, M. C. Devendrachari, Z. M. Bhat, R. Thimmappa, H. M. Nimbegondi Kotresh, C. P. Vinod, M. O. Thotiyl, Geometrical Isomerism Directed Electrochemical Sensing. Anal. Chem. 92, 4541-4547 (2020).
8. T. Gupte, S. K. Jana, J. S. Mohanty, P. Srikrishnarka, S. Mukherjee, T. Ahuja, C. Sudhakar, T. Thomas, T. Pradeep, Highly Sensitive As3+Detection Using Electrodeposited Nanostructured MnOx and Phase Evolution of the Active Material during Sensing. ACS Appl. Mater. Interfaces 11, 28154-28163 (2019).
9. D. R. Shobha Jeykumari, S. Ramaprabhu, S. Sriman Narayanan, A thionine functionalized multiwalled carbon nanotube modified electrode for the determination of hydrogen peroxide. Carbon 45, 1340-1353 (2007).
10. T. Swamy, Y.-M. Chiang, Electrochemical Charge Transfer Reaction Kinetics at the Silicon-Liquid Electrolyte Interface. J. Electrochem. Soc. 162, A7129-A7134 (2015).
11. P. Krishnaveni, V. Ganesh, Electron transfer studies of a conventional redox probe in human sweat and saliva bio-mimicking conditions. Sci. Rep. 11, 1-13 (2021).

1.-53. (canceled)

54. A composite material represented by a formula M/C, wherein M is at least one metal material and C is at least one carbon material, wherein said composite material is for electrocatalysis in an oxygen reduction reaction (ORR) and/or in a peroxide oxidation reaction (POR).

55. The composite material of claim 54, wherein said ORR comprises reduction of oxygen to hydrogen peroxide (H₂O₂) or a peroxide anion thereof (HO₂⁻) and/or said OPR comprises oxidation of H₂O₂ or HO₂⁻ to oxygen.

56. The composite material of claim 55, wherein said reduction of oxygen to H₂O₂ or HO₂⁻ is with a selectivity of at least 90% and/or involves a two-electrons transfer.

57. The composite material of claim 55, wherein said reduction of oxygen to H₂O₂ or HO₂⁻ is with a selectivity of at least 93%.

58. The composite material of claim 54, exhibiting reversible activity for the reduction of oxygen to H₂O₂ or HO₂⁻ during the ORR and for the oxidation of H₂O₂ or HO₂⁻ to oxygen during the POR.

59. The composite material of claim 54, being stable over at least 100 hours of electrochemical cycling.

60. The composite material of claim 54, wherein said at least one metal material is at least one of (i) at least one alkali metal, (ii) at least one alkaline earth metal, (iii) at least one transition metal, (iv) at least one post-transition metal or (v) a combination thereof-, optionally wherein said at least one metal material is at least one of V, Cr, Mn, Fe, Co, Ni, Cu, Zn, Mo, W, In, Sn, Sb, Al, Bi, Mg, Ca, Na, K, Rb, Sr, Cs, Ba, Ce, Eu, Y, Zr, or a combination thereof.

61. The composite material of claim 54, wherein said at least one metal material is Fe, Co, Ni or a combination thereof.

62. The composite material of claim 54, comprising at least one heteroatom.

63. The composite material of claim 62, wherein said at least heteroatom being one or more of N, S, B, P, O, F, Cl, Br, I, or a combination thereof.

64. An electrochemical cell comprising an electrode assembly comprising a working electrode and a counter electrode, wherein said working electrode is or is at least partially coated with a composite material represented by a formula MIC, wherein M is at least one metal material and C is at least one carbon material.

65. The electrochemical cell of claim 64, wherein said composite material (i) is for electrocatalysis ORR, (ii) exhibits activity for the reduction of oxygen to H₂O₂ or HO₂⁻ during the ORR, (iii) for electrocatalysis POR, (iv) exhibits activity for the oxidation of H₂O₂ or HO₂⁻ to oxygen during the POR.

66. The electrochemical cell claim 65, being an ORR flow-cell, an electrolysis cell (electrolyzer), a H₂O₂ sensor or a rechargeable battery.

67. The electrochemical cell of claim 64, wherein said counter electrode is configured to produce H₂.

68. A system comprising one or more electrochemical cells, wherein said one or more electrochemical cells is as defined in claim 64.

69. A battery comprising an electrode assembly comprising a working electrode and a counter electrode, wherein said working electrode is or comprises a material that exhibits reversible activity for the reduction of oxygen to H₂O₂ or HO₂⁻ during ORR and for the oxidation of H₂O₂ or HO₂⁻ to oxygen during POR.

70. The battery of claim 60, wherein said material is configured to undergo reversible reduction-oxidation, wherein said reduction is reduction of oxygen to H₂O₂ or HO₂⁻ during ORR and said oxidation is oxidation of H₂O₂ or HO₂⁻ to oxygen during POR.

71. The battery of claim 60, configured to operate such that during discharge the working electrode serves as a cathode and the counter electrode serves as an anode.

72. The battery of claim 69, wherein said working electrode is positioned in a first compartment and said counter electrode is positioned in a second compartment, wherein said first compartment and said second compartment are partitioned by a membrane, optionally wherein said membrane is an anion exchange membrane.

73. The battery of claim 69 being a rechargeable battery.
